(19) United States
(12) Patent Application Publication
(10) Pub. No.: US 2018/0374105 A1
(43) Pub. Date: Dec. 27, 2018

(54) LEVERAGING AN INTERMEDIATE MACHINE LEARNING ANALYSIS

(71) Applicant: Get Attached, Inc., New York, NY (US)

(72) Inventors: Albert Azout, Palo Alto, CA (US); Douglas Imbruce, New York, NY (US); Gregory T. Pape, New York, NY (US)

(21) Appl. No.: 15/714,741

(22) Filed: Sep. 25, 2017

Related U.S. Application Data
(63) Continuation-in-part of application No. 15/607,026, filed on May 26, 2017.

(51) Int. Cl. G06Q 30/02; G06N 99/00; G06N 5/04

(52) U.S. Cl. CPC G06Q 30/0201; G06N 5/04; G06N 99/005

(57) ABSTRACT

A media and a context information associated with the media are received. A first machine learning model and a second machine learning model are trained using different machine learning training data sets. Using the first machine learning model, the media is analyzed to determine a classification result. Using the second machine learning model, the classification result and the context information are analyzed to determine whether the media is likely not desirable to share. In an event the media is not identified as not desirable to share, the media is automatically shared.

### CROSS REFERENCE TO OTHER APPLICATIONS

This application is a continuation-in-part of co-pending U.S. patent application Ser. No. 15/607,026 entitled USING ARTIFICIAL INTELLIGENCE AND MACHINE LEARNING TO AUTOMATICALLY SHARE DESIRED DIGITAL MEDIA filed May 26, 2017 which is incorporated herein by reference for all purposes.

### BACKGROUND OF THE INVENTION

Traditional passive capture devices are able to passively capture a scene in the form of video, audio, and photos. Continuously capturing a scene typically generates a considerable amount of data that often contains images that are very similar from one moment to another. To minimize storage requirements and highlight important events, it is common that passive capture devices only record a scene when there is movement. Some systems will identify zones in the captured scene and trigger recording only when movement or changes are detected in the prescribed zones. The recording length may be based on a set duration or when the passive capture device no longer detects movement. From a sharing and user content consumption perspective, it is desirable to automatically identify sharable events from a passive capture feed. Once an event is identified and recorded into digital media, it may be shared with an audience.

Traditional digital media sharing allows a user to identify one or more photos or videos for sharing with an audience. The user typically reviews recently taken media to determine which ones are desirable for sharing. Once shared, the user may receive feedback in different forms such as audience comments, “likes,” and having a shared media marked as a favorite or popular item. In some instances, based on the feedback from the user's audience, the user may adjust or refine the type of photos or videos identified for sharing to increase the audience's participation. Similar to events detected based on movement or motion detection, this form of feedback does not necessarily identify which media is the most engaging for the user's audience. The feedback will often result in promoting media that attracts instant and only superficial attention. From a sharing and user content consumption perspective, it is desirable to automatically identify content, including content from a passive capture feed, which creates a deeper and richer audience engagement experience.

### BRIEF DESCRIPTION OF THE DRAWINGS

Various embodiments of the invention are disclosed in the following detailed description and the accompanying drawings.

FIG. 1 is a block diagram illustrating an example of a communication environment between a client and a server for sharing and/or accessing digital media.

FIG. 2 is a functional diagram illustrating a programmed computer system for sharing and/or accessing digital media in accordance with some embodiments.

FIG. 3 is a flow diagram illustrating an embodiment of a process for automatically sharing desired digital media.

FIG. 4 is a flow diagram illustrating an embodiment of a process for classifying digital media.

FIG. 5 is a flow diagram illustrating an embodiment of a process for the creation and distribution of a machine learning model.

FIG. 6 is a flow diagram illustrating an embodiment of a process for automatically sharing desired digital media.

FIG. 7A is a flow diagram illustrating an embodiment of a process for applying a context-based machine learning model.

FIG. 7B is a flow diagram illustrating an embodiment of a process for applying a multi-model context-based machine learning architecture.

FIG. 8 is a flow diagram illustrating an embodiment of a process for applying a multi-stage machine learning architecture.

FIG. 9 is a flow diagram illustrating an embodiment of a process for training and distributing a multi-stage machine learning architecture.

FIG. 10 is a flow diagram illustrating an embodiment of a process for automatically providing digital media feedback.

FIG. 11 is a flow diagram illustrating an embodiment of a process for training and distributing an engagement-based machine learning model.

FIG. 12 is a flow diagram illustrating an embodiment of a process for applying an engagement-based machine learning model.

FIG. 13 is a flow diagram illustrating an embodiment of a process for applying a multi-stage machine learning model.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatically analyzing media (e.g., photo, video, etc.) using a machine learning model trained on user engagement information is disclosed. For example, using artificial intelligence/machine learning, passive capture devices are able to automatically identify an event having a high likelihood of user engagement, initiate recording of the event, and automatically share a digital recording of the captured event with a target audience. A passive capture device, such as a smartphone camera, a wearable camera device, a robot equipped with recording hardware, an augmented reality headset, an unmanned aerial vehicle, or other similar devices, can be setup to have a continuous passive capture feed of its surrounding scene. The passive capture feed creates a digital representation of events as they take place. The format of the event may include a video of the event, a photo or sequence of photos of the event, an audio recording of the event, and/or a virtual 3D representation of the event, among other formats. In some embodiments, the scenes of the event are split into stills or snapshots for analysis.

In addition to the captured digital media, context from the event is utilized in the analysis and is retrieved from the device's sensors and/or from one or more network resources. Context information may include information such as the location of the event, the type of device recording the event, the time of day of the event, the current weather at the location of the event, and other similar parameters gathered from the sensors of the device or from a remote service. Additional parameters may include context information such as lighting information, camera angle, device speed, device acceleration, and altitude, among other things. In some embodiments, additional context information is utilized in the analysis and the context information may include content-based features such as the number and identity of faces in the scene as well as environmental-based features such as whether the location is a public place and whether WiFi is available. Using a machine learning model trained on user engagement and context information, the analysis determines the probability that the given event is desirable for sharing. In some embodiments, events that have a high likelihood of being engaging are automatically shared. In some embodiments, the desirability of the media for sharing is based on user engagement metrics. Further, each scene may be analyzed to determine whether it is duplicative of a previous shared media and duplicative scenes may be discarded and not shared. The analysis uses machine learning to determine whether a scene is duplicative based on previously recorded scenes.

In some embodiments, an engagement-based machine learning model is created and utilized for identifying and sharing desirable and engaging media. A computer server receives engagement information regarding one or more previously shared media from one or more recipients of the previously shared media. For example, engagement information is gathered from users of a social media sharing application based on previously shared media, such as shared photos and videos. The engagement information may be based on feedback such as browsing indicators, comments, depth of comments, re-sharing status, and depth of sharing, among other factors. Examples of browsing indicators include gaze, focus, pinch, zoom, and rotate indicators, among others. The engagement information is received from various users and used along with a version of the shared media to train an engagement-based machine learning model. In some embodiments, the machine learning model also receives context information related to the shared media and utilizes the context information for training. For example, context information may include the location, the number and/or identity of faces in the media, the lighting information, and whether the location is a public or private location, among other features.

Once trained, the machine learning model is prepared for distribution to client devices where inference on eligible media may be performed. The client devices receive a stream of media eligible to be automatically shared. For example, a passive capture client device receives a stream of passive captured media from a passive capture feed that is a candidate for sharing. As another example, a user with a wearable camera device such as a head-mounted wearable camera device passively captures images from the perspective of the user. Each scene or image the device captures is eligible for sharing. As further examples, a robot equipped with recording hardware and an unmanned aerial vehicle are client devices that may passively capture a stream of media eligible to be automatically shared. The eligible media is analyzed using the trained engagement-based machine learning model on the client device. In some embodiments, a machine learning model is used to analyze a subset of the media in the stream of eligible media. For example, a stream of video may be split into still images that are analyzed using the machine learning model.

Based on the analysis of the media included in the stream of media, a determination is made on whether the streamed media is desirable for automatic sharing. For example, in the event the media has a high probability of user engagement, the media may be marked as desirable for sharing and automatically shared. Conversely, in the event the media has a low probability of user engagement, the media may be marked as undesirable for sharing and will not be automatically shared. In some embodiments, media desirable for sharing triggers the recording of media, which is then automatically shared. In various embodiments, the analysis may also trigger ending the recording of media. In various embodiments, media may be first recorded before being analyzed for sharing. For example, media may be created in short segments that are individually analyzed for desirability. Multiple continuous desirable segments may be stitched together to create a longer continuous media that is automatically shared.

In some embodiments, the analysis of the media for automatic sharing includes a determination that the media is duplicative. For example, in a scene with little movement, two images taken minutes apart may appear nearly identical. In the event that the first image is determined to be desirable for sharing and is automatically shared, the second image has little additional engagement value and may be discarded as duplicative. In some embodiments, images that are determined to be duplicative do not need to be identical copies but only largely similar. In some embodiments, the de-duplication of media is a part of the determination of the media's engagement value. In other embodiments, the de-duplication is separate from a determination of engagement value. For example, media determined to be duplicative of media previously shared is discarded and not fully analyzed for engagement value.

In some embodiments, media is not automatically shared in the event that the analysis of the media determines that the media is not desirable for sharing. For example, for some users, media that contains nudity is not desirable for sharing and will be excluded from automatically being shared. Similarly, for some users, media that contains medical and health information is not desirable for sharing and will be excluded from automatically being shared. To determine whether a media is not desirable for sharing, a machine learning model may be used to infer the likelihood a media is not desirable for sharing. In some embodiments, the machine learning model consists of multiple machine learning model components. The input to the first machine learning model component includes at least an input image. Inference using the first machine learning model component results in an intermediate machine learning analysis result. The intermediate machine learning analysis result is used as one of the inputs to a second machine learning model component.

In some embodiments, a first machine learning model is used to analyze media to determine a classification result. A second machine learning model is then used to analyze the classification result and context information associated with the media to determine the likelihood the media is not desirable for sharing. The first machine learning model and second machine learning model are trained using different machine learning training data sets. For example, the two machine learning models may be trained independently. The first machine learning model may be a public pre-trained model that utilizes open source corpora. The second machine learning model may be a group model that is personalized to a user or a group of users and may be trained based on data collected from the behavior of users from the group.

In some embodiments, a first machine learning model includes a first machine learning model component and second machine learning model component. The first machine learning model component is used to output an intermediate machine learning analysis result that may be leveraged for additional analysis. The second machine learning model component utilizes the intermediate machine learning result to determine a classification result. For example, inference may be applied using a media as input to a machine learning model to determine a result, such as a vector of probabilities that the media belongs to one of a given set of categories. In the event that the machine learning model includes two machine learning model components, the output of the first machine learning model component is used by the second machine learning component to infer classification results.

In some embodiments, a second machine learning model analyzes the classification results of the first machine learning model to determine whether the media is likely not desirable to share. In some embodiments, the second machine learning model is a binary classifier that infers whether eligible media should be marked private or shared. For example, a second machine learning model takes as input the classification results and context information of the analyzed media to determine whether the media should be automatically shared or should remain private. The additional context information may include information such as the location of the media, whether the location is a private or public location, whether WiFi access is available at the location, the time of day the media was captured, and camera and lighting information, among other features. The second machine learning model is also trained but may utilize a different and smaller corpus than the first machine learning model. The second machine learning model is trained to infer the likelihood that the media is likely not desirable to share. Examples of media not desirable for sharing may include financial documents and images with nudity.

In some embodiments, the level of tolerance for sharing different media differs by the user and audience. In some embodiments, the second machine learning model used for inferring the likelihood that the media is not desirable to share is based on preferences and/or behaviors of the user and/or the user's audience. The second machine learning model may be customized for each user and/or audience. In some embodiments, similar users and/or audiences are clustered together to create a group machine learning model based on a group of users or a target audience group. In the example described, the first machine learning model and the second machine learning model are trained independently using different machine learning training data sets and are used to infer different results. In some embodiments, the second machine learning model may require significantly fewer processing resources and data collection efforts. In some embodiments, the different machine learning models may be updated and evolve independently.

In some embodiments, an intermediate machine learning analysis result is outputted that is used as a marker of the media. For example, the output of the first machine learning model component is an intermediate machine learning analysis result. In some embodiments, the intermediate machine learning analysis result is a lower dimensional representation of the analyzed media. The lower dimensional representation may be used to identify the analyzed media but may not be used to reconstruct the original media. As a marker of the media, the intermediate machine learning analysis result may be used for identifying the differences between two media by comparing the intermediate machine learning analysis results of the different media. The marker of the media may also be used for training a machine learning model where privacy requirements do not allow private media to leave the capture device. In this scenario, private media may not be used in a training corpus but the marker of the media, by anonymizing the visual content of the image, may be used in training the machine learning model.

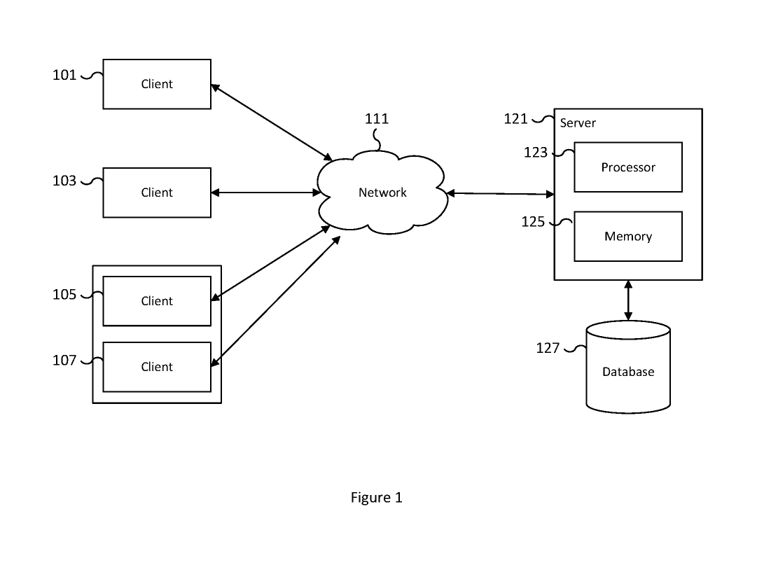

FIG. 1 is a block diagram illustrating an example of a communication environment between a client and a server for sharing and/or accessing digital media. In the example shown, clients 101, 103, 105, and 107 are network computing devices with media for sharing and server 121 is a digital media sharing server. Examples of network computer devices include but are not limited to a smartphone device, a tablet, a laptop, a virtual reality headset, an augmented reality device, a network connected camera, a wearable camera, a robot equipped with recording hardware, an unmanned aerial vehicle, a gaming console, and a desktop computer. Clients 101, 103, 105, and 107 are connected to server 121 via network 111. Clients 105 and 107 are grouped together to represent network devices accessing server 121 from the same location. In some embodiments, clients 105 and 107 may be devices sharing the same local network. In some embodiments, clients 105 and 107 may share the same general physical location and may or may not share the same network. For example, clients 105 and 107 may be two recording devices, such as an unmanned aerial vehicle and a smartphone device. The two devices may share the same general physical location, such as a wedding or sporting event, but access server 121 via network 111 using two different networks, one using a WiFi connection and another using a cellular connection. Examples of network 111 include one or more of the following: a mobile communication network, the Internet, a direct or indirect physical communication connection, a Wide Area Network, a Storage Area Network, and any other form of connecting two or more systems, components, or storage devices together.

Users of clients 101, 103, 105, and 107 generate digital media such as photos, videos, interactive scenes in virtual worlds, etc. For example, client 101 may be a smartphone device that a user creates photos and videos with by using the smartphone's camera. As photos and videos are taken with client 101, the digital media is saved on the storage of client 101. The user of client 101 desires to share only a selection of the digital media on the device without any interaction by the user of client 101. Some photos and videos may be private and the user does not desire to share them. As an example, the user may not desire to automatically share photos of documents, which may include photos of financial statements, personal records, credit cards, and health records. As another example, the user may not desire to automatically share photos that contain nudity. In another example, the user may not desire to automatically share screenshot images/photos.

In the example shown, users of clients 101, 103, 105, and 107 selectively share their digital media with others automatically based on sharing desirability. The media generated by clients 101, 103, 105, and 107 is automatically detected and analyzed using a machine learning model to classify the detected media into categories. Based on the identified category, media is marked for sharing and automatically uploaded through network 111 to server 121 for sharing. In some embodiments, the classification is performed on the client such as on clients 101, 103, 105, and 107. For example, a background process detects new media, such as photos and videos, as they are created on a client, such as client 101. Once detected, a background process automatically analyzes and classifies the media. A background process then uploads the media marked as desirable for sharing to a media sharing service running on a server such as server 121. In some embodiments, the detection, analysis and marking, and uploading process may be performed as part of the media capture processing pipeline. For example, a network connected camera may perform the detection, analysis and marking, and uploading process during media capture as part of the processing pipeline. In some embodiments, the detection, analysis and marking, and uploading process may be performed by an embedded system. In some embodiments, the detection, analysis and marking, and uploading process may be performed in a foreground application. In various embodiments, server 121 shares the shared media with approved contacts. For example, server 121 hosts the shared media and makes it available for approved clients to interact with the shared media. Examples of interaction may include but are not limited to viewing the media, zooming in on the media, leaving comments related to the media, downloading the media, modifying the media, and other similar interactions. In some embodiments, the shared media is accessible via an application that runs on a client, such as on clients 101, 103, 105, and 107 that retrieves the shared media from server 121. Server 121 uses processor 123 and memory 125 to process, store, and host the shared media. In some embodiments, the shared media and associated properties of the shared media are stored and hosted from database 127.

In some embodiments, client 101 contains an approved list of contacts for viewing shared media that includes client 103 but does not include clients 105 and 107. For example, photos automatically identified by client 101 for sharing are automatically uploaded via network 111 to server 121 for automatic sharing. Once shared, the shared photos are accessible by the originator of the photos and any contacts on the approved list of contacts. In the example, client 101 and client 103 may view the shared media of client 101. Clients 105 and 107 may not access the shared media since neither client 105 nor client 107 is on the approved list of contacts. Any media on client 101 classified as not desirable for sharing is not uploaded to server 121 and remains only accessible by client 101 from client 101 and is not accessible by clients 103, 105 and 107. The approved list of contacts may be maintained on a per user basis such that the list of approved sharing contacts of client 101 is configured based on the input of the user of client 101. In some embodiments, the approved list of contacts may be determined based on device, account, username, email address, phone number, device owner, corporate identity, or other similar parameters. In some embodiments, the shared media may be added to a profile designated by a media publisher. In some embodiments, the profile is shared and/or made public.

In some embodiments, the recipients for sharing are determined by the identity of the recipients in the media. For example, each user whose face is identified in the candidate media is a candidate for receiving the shared media. In some embodiments, the location of the user is used to determine whether the candidate receives the media. For example, all users attending a wedding may be eligible for receiving media captured at the wedding. In various embodiments, the user's approved contacts, the identity of users in the candidate media, and/or the location of users may be used to determine the recipients of shared media.

In some embodiments, the media on clients 101, 103, 105, and 107 is automatically detected and uploaded via network 111 to server 121. Once the media is uploaded to server 121, server 121 automatically analyzes the uploaded media using a machine learning model to classify the detected media into one or more categories. Based on an identified category, media is marked for sharing and automatically made available for sharing on server 121. For example, client 101 detects all generated media and uploads the media via network 111 to server 121. Server 121 performs an analysis on the uploaded media and, using a machine learning model, classifies the detected media into media approved for sharing and media not for sharing. Server 121 makes the media approved for sharing automatically available to approved contacts configured by client 101 without any interaction required by client 101.

In some embodiments, the collection of digital media on clients 101, 103, 105, and 107 is viewed using a user interface for accelerated media browsing. In some embodiments, context aware browsing includes receiving input gestures on the devices of clients 101, 103, 105, and 107. Properties associated with the media used for context aware browsing and automatic feedback of digital media interaction may be stored in database 127 and sent along with the media to consumers of the media such as clients 101, 103, 105, and 107. In some embodiments, when a digital media viewed on clients 101, 103, 105, and/or 107 is displayed for at least a threshold amount of time, an indication is provided to the user of the corresponding device. For example, the user of clients 101, 103, 105, and/or 107 may receive a gaze indication and a corresponding visual indicator of the gaze indication. An example of a visual indicator may be a digital sticker displayed on the viewed media. Other examples include a pop-up, various overlays, a floating icon, an emoji, a highlight, etc. In some embodiments, a notification associated with the indication is sent over network 111 to server 121. In some embodiments, the notification includes information associated with an interaction with the shared media. For example, the information may include the particular media that was viewed, the length of time it was viewed, the user who viewed the media, the time of day and location the media was viewed, feedback (e.g., comments, share status, annotations, etc.) from the viewer on the media, and other additional information. In some embodiments, server 121 receives the notification and stores the notification and/or information related to the notification in database 127.

In some embodiments, one or more of clients 101, 103, 105, and 107 may be passive capture devices. Passive capture devices monitor the scene and automatically record and share selective events that are determined to be engaging for either the user or the user's audience for sharing. In various embodiments, the passive capture devices have a passive capture feed and only record and convert the feed into captured digital media when an engaging event occurs. An event is determined to be engaging by applying a machine learning analysis using an engagement model to the current scene. In some embodiments, an engaging event is one that is determined to be both desirable for sharing and does not meet the criteria for not desirable for sharing. For example, a birthday celebration at a public location may be determined to be an engaging event and is automatically shared. In contrast, a birthday dinner at a private location that is intended to be an intimate celebration may be determined to be engaging but also determined to be not desirable for sharing and thus will not be shared. In some embodiments, the determination that an event is not desirable for sharing is separate from the engagement analysis.

In various embodiments, the components shown in FIG. 1 may exist in various combinations of hardware machines. Although single instances of components have been shown to simplify the diagram, additional instances of any of the components shown in FIG. 1 may exist. For example, server 121 may include one or more servers for hosting shared media and/or performing analysis of detected media. Components not shown in FIG. 1 may also exist.

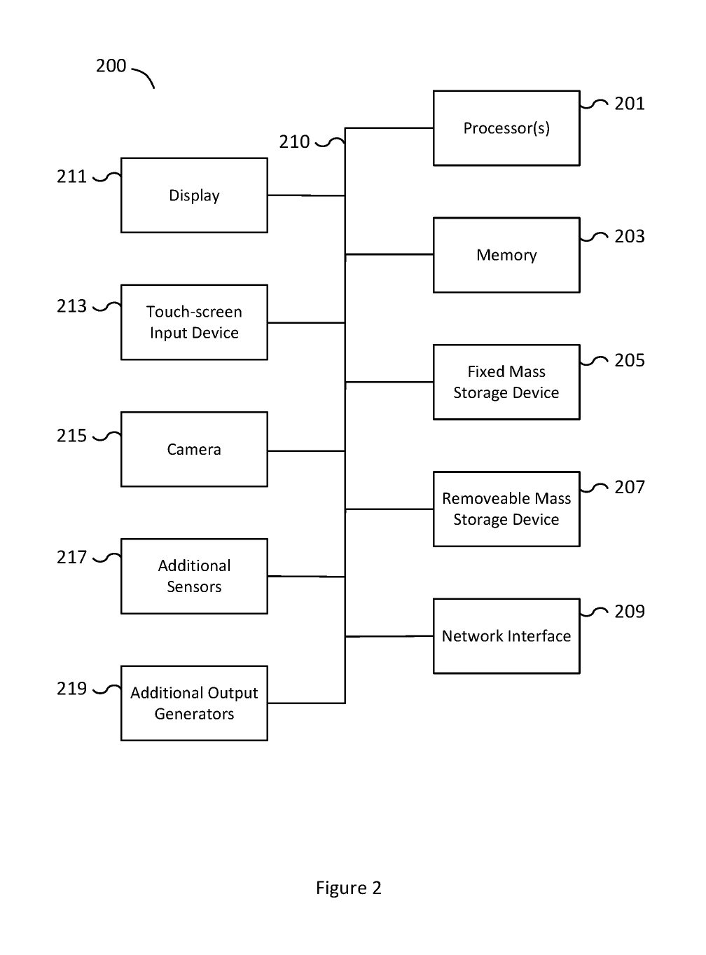

FIG. 2 is a functional diagram illustrating a programmed computer system for sharing and/or accessing digital media in accordance with some embodiments. As will be apparent, other computer system architectures and configurations can be used to perform automatic sharing of desired digital media. Computer system 200, which includes various subsystems as described below, includes at least one microprocessor subsystem (also referred to as a processor or a central processing unit (CPU)) 201. In some embodiments, computer system 200 is a virtualized computer system providing the functionality of a physical computer system. For example, processor 201 can be implemented by a single-chip processor or by multiple processors. In some embodiments, processor 201 is a general purpose digital processor that controls the operation of the computer system 200. In some embodiments, processor 201 may support specialized instruction sets for performing inference using machine learning models. Using instructions retrieved from memory 203, the processor 201 controls the reception and manipulation of input data, and the output and display of data on output devices (e.g., display 211).

In some embodiments, processor 201 is used to provide functionality for sharing desired digital media including automatically analyzing new digital media using an engagement-based machine learning model to determine whether the media is desirable to be automatically shared. In some embodiments, processor 201 includes and/or is used to provide functionality for automatically sharing desired digital media by analyzing the media and its context information using a first and second machine learning model that are independently trained. In some embodiments, processor 201 includes and/or is used to provide functionality for receiving digital media and for providing an indication and sending a notification in the event the media has been displayed for at least a threshold amount of time.

In some embodiments, processor 201 is used for the automatic analysis of media using a machine learning model trained on user engagement information. Processor 201 is used to receive engagement information from recipients of previously shared media and train a machine learning model using the received engagement information. In some embodiments, processor 201 is used to receive a stream of media eligible for automatic sharing and using a machine learning model, analyze media included in the stream. Based on the analysis of the media, processor 201 is used to determine that the media is desirable for automatic sharing and automatically shares the media from the stream of media.

In some embodiments, processor 201 is used for leveraging an intermediate machine learning analysis. Processor 201 uses a first machine learning model to analyze a received media to determine a classification result. Processor 201 then uses a second machine learning model to analyze the classification result to determine whether the media is likely not desirable to share. In various embodiments, the first and second machine learning models are trained using different machine learning data sets. In some embodiments, processor 201 outputs the intermediate machine learning analysis result to use as a marker of the media, as described in further detail below.

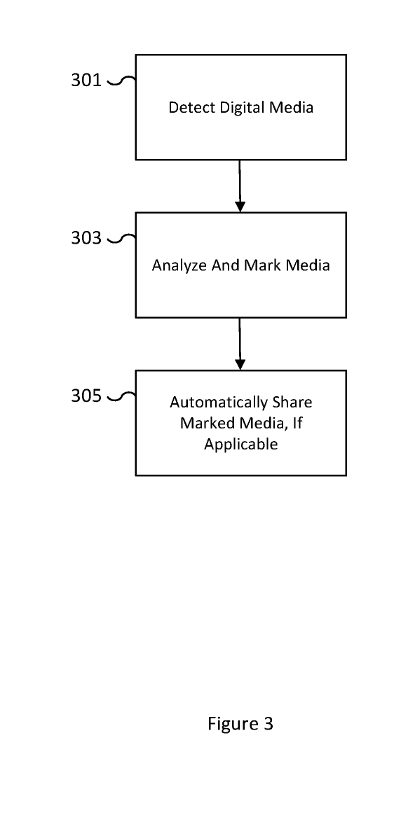

In some embodiments, processor 201 includes and/or is used to provide elements 101, 103, 105, 107, and 121 with respect to FIG. 1 and/or performs the processes described below with respect to FIGS. 3-13.

Processor 201 is coupled bi-directionally with memory 203, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 201. Also as is well known in the art, primary storage typically includes basic operating instructions, program code, data, and objects used by the processor 201 to perform its functions (e.g., programmed instructions). For example, memory 203 can include any suitable computer-readable storage media, described below, depending on whether, for example, data access needs to be bi-directional or uni-directional. For example, processor 201 can also directly and very rapidly retrieve and store frequently needed data in a cache memory (not shown).

A removable mass storage device 207 provides additional data storage capacity for the computer system 200, and is coupled either bi-directionally (read/write) or uni-directionally (read only) to processor 201. For example, storage 207 can also include computer-readable media such as flash memory, portable mass storage devices, magnetic tape, PC-CARDS, holographic storage devices, and other storage devices. A fixed mass storage 205 can also, for example, provide additional data storage capacity. Common examples of mass storage 205 include flash memory, a hard disk drive, and an SSD drive. Mass storages 205, 207 generally store additional programming instructions, data, and the like that typically are not in active use by the processor 201. Mass storages 205, 207 may also be used to store digital media captured by computer system 200. It will be appreciated that the information retained within mass storages 205 and 207 can be incorporated, if needed, in standard fashion as part of memory 203 (e.g., RAM) as virtual memory.

In addition to providing processor 201 access to storage subsystems, bus 210 can also be used to provide access to other subsystems and devices. As shown, these can include a display 211, a network interface 209, a touch-screen input device 213, a camera 215, additional sensors 217, additional output generators 219, and as well as an auxiliary input/output device interface, a sound card, speakers, a keyboard, additional pointing devices, and other subsystems as needed. For example, the additional sensors 217 may include a location sensor, an accelerometer, a heart rate monitor, and/or a proximity sensor, and may be useful for interacting with a graphical user interface and/or capturing additional context to associate with digital media. As other examples, the additional output generators 219 may include tactile feedback motors, a virtual reality headset, and augmented reality output.

The network interface 209 allows processor 201 to be coupled to another computer, computer network, or telecommunications network using one or more network connections as shown. For example, through the network interface 209, the processor 201 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 201 can be used to connect the computer system 200 to an external network and transfer data according to standard protocols. For example, various process embodiments disclosed herein can be executed on processor 201, or can be performed across a network such as the Internet, intranet networks, or local area networks, in conjunction with a remote processor that shares a portion of the processing. Additional mass storage devices (not shown) can also be connected to processor 201 through network interface 209.

An auxiliary I/O device interface (not shown) can be used in conjunction with computer system 200. The auxiliary I/O device interface can include general and customized interfaces that allow the processor 201 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above and magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 2 is but an example of a computer system suitable for use with the various embodiments disclosed herein. Other computer systems suitable for such use can include additional or fewer subsystems. In addition, bus 210 is illustrative of any interconnection scheme serving to link the subsystems. Other computer architectures having different configurations of subsystems can also be utilized.

FIG. 3 is a flow diagram illustrating an embodiment of a process for automatically sharing desired digital media. In some embodiments, the process of FIG. 3 is implemented on clients 101, 103, 105, and 107 of FIG. 1. In some embodiments, the process of FIG. 3 is implemented on server 121 of FIG. 1. In some embodiments, the process of FIG. 3 occurs without active participation or interaction from a user.

In the example shown, at 301, digital media is automatically detected. For example, recently created digital media, such as photos or videos newly taken, is detected for processing. As another example, digital media that has not previously been analyzed at 303 (as discussed below) is detected. In some embodiments, the detected media is stored on the device. In some embodiments, the detected media is live media, such as a live video capture. In some embodiments, the live media is media being streamed. As an example, a live video may be a video conference feed. In some embodiments, the live video is streamed and not stored in its entirety. In some embodiments, the live video is divided into smaller chunks of video which are saved on the device for analysis.

At 303, the detected digital media is automatically analyzed and marked. The analysis of digital media is performed using machine learning and artificial intelligence. In some embodiments, the analysis using machine learning and artificial intelligence classifies the detected media into categories. For example, a machine learning model is trained using a corpus of photos from multiple categories. The training results in a machine learning model with trained weights. Inference is run on each detected media to classify it into one or more categories using the trained multi-classifier. Categories may include one or more of the following: approved, documents, screenshots, unflattering, blurred, gruesome, medically-oriented, and private, among others. In some embodiments, private media is media that may contain nudity. In some embodiments, the analysis classifies the media into a single category. In some embodiments, the analysis classifies the media into more than one categories. In some embodiments, the output of a multi-classifier is a probability distribution across all categories. In some embodiments, different thresholds may exist for identifying whether a media belongs to a particular category. For example, in the event that the analysis is tuned to be more sensitive to nudity, a threshold for classification for nudity may be lower than the threshold for documents. In some embodiments, the output of classification is further analyzed, for example, by using one or more additional stages of machine learning and artificial intelligence. In some embodiments, one or more additional stages of machine learning and artificial intelligence are applied prior to classification. For example, image recognition may be applied using a machine learning model prior to classification. In various embodiments, the identified categories determine if the analyzed media is desirable for sharing. As an example, the categories documents and private may not be desired for sharing. In some embodiments, the remaining categories that are not marked not desired for sharing are approved for sharing. The analyzed media is automatically marked for sharing or not for sharing based on classification. In some embodiments, all digital media captured and/or in specified folder(s) or album(s) is to be automatically shared unless specifically identified/classified as not desirable to share.

At 305, the analyzed digital media is automatically shared, if applicable. For example, in the event the media is not marked for not desirable for sharing, it is automatically shared. For example, in the event the media is marked as not desirable for sharing, it is not uploaded for sharing with specified/approved contact(s) and other media (e.g., all media captured by user device or all media in specified folder(s) or album(s)) not marked as not desired for sharing) is automatically shared. In some embodiments, despite a digital media being not identified/marked as not desirable to share, a user may manually identify/mark the media as not desirable to share and this media is not automatically shared. In some embodiments, a media that has been automatically shared may be removed from sharing. For example, the user that automatically shared the media may apply an indication to no longer share the media. In another example, in the event the media is marked desirable to share, it is automatically shared. For example, only media specifically identified/marked using machine learning as desirable for sharing is automatically shared. In some embodiments, despite a digital media being identified/marked as not desirable to share, a user may manually identify/mark the media as desirable to share and this media is automatically shared.

In some embodiments, if the media is marked for sharing, it is automatically uploaded to a media sharing server such as server 121 of FIG. 1 over a network such as network 111 of FIG. 1. In some embodiments, the uploading of media for sharing is performed as a background process without user interaction. In various embodiments, the uploading is performed in a process that is part of a foreground application and that does not require user interaction. In various embodiments, the media is shared with approved contacts. For example, an approved contact may receive a notification that newly shared media from a friend is available for viewing. The approved contact may view the shared media in a media viewing application. In another example, the newly shared media will appear on the devices of approved contacts at certain refresh intervals or events. In some embodiments, prior to automatically sharing the media, the user is provided a message or indication that the media is going to be automatically shared (e.g., after a user configurable time delay) and unless otherwise instructed by the user, the media is automatically shared. For example, a user is provided a notification that twelve recently taken photos are going to be automatically shared after a time delay period of ten minutes. Within this time delay period, the user has the opportunity to preview the photos to be automatically shared and instruct otherwise to not share indicated one(s) of the photos.

In some embodiments, the media marked for sharing is shared after a configurable time delay. In some embodiments, the user may bypass the time delay for sharing media marked for sharing. For example, the user may express the user's desire to immediately share media marked for sharing. In some embodiments, the user bypasses a time delay for sharing media marked for sharing by performing a shaking gesture. For example, a user may shake a device, such as a smartphone, to indicate the user's desire to bypass the time delay for sharing media marked for sharing. In some embodiments, a sensor in the device, such as an accelerometer, is used to detect the shaking gesture and triggers the sharing. As other examples, a user may bypass a time delay for sharing media marked for sharing by interacting with a user interface element, such as a button, control center, sharing widget, or other similar user interface element. In some embodiments, the media marked for sharing is first released and then shared. In some embodiments, once a media is released, it is shared immediately. In some embodiments, the media marked for sharing is first released and then shared at a next available time made for processing sharing media.

In some embodiments, a user interface is provided to display to the user media marked for sharing and media marked not for sharing. In some embodiments, the user interface displays a share status for media marked for sharing. For example, the share status may indicate that the media is currently shared, the media is private and not shared, the media is pending sharing, and/or a time associated with when media marked for sharing will be released and shared. In some embodiments, a media pending sharing is a media that is in the process of being uploaded and shared. In some embodiments, a media pending sharing is a media that has been released for sharing but has not been shared. For example, a media may be released for sharing but not shared in the event that the device is unable to connect to a media sharing service (e.g., the device is in an airplane mode with network connectivity disabled). In some embodiments, a media marked for sharing but not released has a countdown associated with the release time. In some embodiments, prior to sharing and/or after a media has been shared, a media may be made private and will not or will no longer be shared.

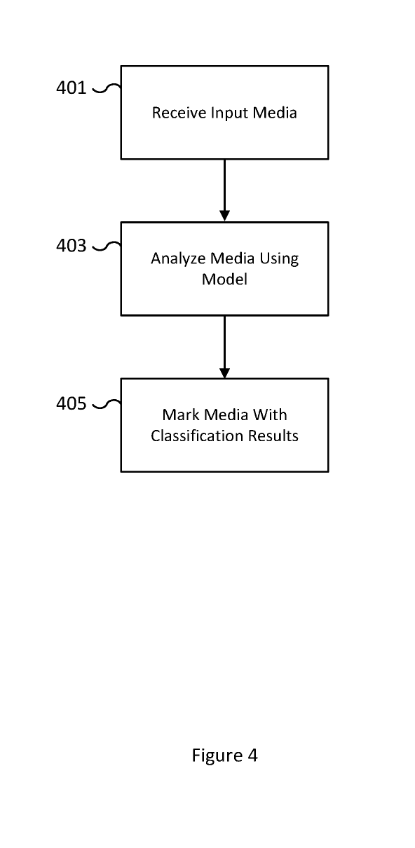

FIG. 4 is a flow diagram illustrating an embodiment of a process for classifying digital media. In some embodiments, the process of FIG. 4 is implemented on clients 101, 103, 105, and 107 of FIG. 1. In some embodiments, the process of FIG. 4 is implemented on server 121 of FIG. 1. In some embodiments, the process of FIG. 4 is performed at 303 of FIG. 3.

In the example shown, at 401, digital media is received as input for classification. For example, a computer process detects the creation of new digital media and passes the new digital media to be received at 401 for classification. In some embodiments, once received, the digital media may be validated. For example, the media may be validated to ensure that it is in the appropriate format, size, color depth, orientation, and sharpness, among other things. In some embodiments, no validation is necessary at 401. In some embodiments, at 401, as part of receiving the digital media, data augmentation is performed on the media. In some embodiments, data augmentation may include applying one or more image processing filters such as translation, rotation, scaling, and skewing. For instance, the media may be augmented using scaling and rotation to create a set of augmented media for analysis. The analysis of each augmented version of media may result in a different classification score. In some scenarios, multiple classification scores are used for classifying a media. In some embodiments, data augmentation includes batching media to improve the computation speed. In some embodiments, validation may take place at 301 of FIG. 3 in the process of detecting digital media.

At 403, a digital media is analyzed and classified into categories. In some embodiments, the result of classification is a probability that the media belongs to one or more categories. In some embodiments, the result of classification is a vector of probabilities. In some embodiments, the classification uses one or more machine learning classification models to calculate one or more values indicating a classification for the media. For example, an input photo is analyzed using a multi-classifier to categorize the photo into one or more categories. Categories may include categories for media that are not desirable for sharing. As an example, a document category and a private category may be categories not desirable for sharing. The document category corresponds to photos identified as photos of documents, which may contain in them sensitive or confidential information. The private category corresponds to photos that may contain nudity. In some embodiments, photos that are not classified into categories not desired for sharing are classified as approved for sharing.

In some embodiments, prior to 403, a corpus of media is curated with multiple categories. In some embodiments, the corpus is human curated. In some embodiments, the categories include approved, documents, and private, where the approved category represents desirable for sharing media. A machine learning model is trained on the corpus to classify media into the identified categories. In some embodiments, the categories are revised over time. In some embodiments, the machine learning model is a deep neural net multi-classifier. In some embodiments, the deep neural net multi-classifier is a convolutional neural network. In some embodiments, the convolutional neural network includes one or more convolution layers and one or more pooling layers followed by a classification, such as a linear classifier, layer.

At 405, the media is marked based on the classification results. Based on the classified categories, the media is automatically identified as not desirable for sharing or desirable for sharing and marked accordingly. For example, if the media is classified to a non-desirable to share category, the media is marked as not desirable for sharing. In some embodiments, the remaining media may be classified as approved for sharing and marked for sharing. In some embodiments, the media is classified into an approved category and is marked for sharing.

In some embodiments, a video is classified by first selecting individual frames from the video. Determining the frames of the video may be performed at 401. The frames are processed into images compatible with the machine learning model of 403 and classified at 403. The output of the classified frames at 403 is used to categorize the video. In 405, the video media is marked as desirable for sharing or not desirable for sharing based on the classification of the frames selected from the video. In some embodiments, if any frame of the video is classified into a category not desirable for sharing then the video is marked as not desirable for sharing. In some embodiments, the frames selected are memorable frames of the video. In some embodiments, memorable frames are based on identifying memorable events or actions in the video. In some embodiments, memorable frames may be based on the number of individuals in the frame, the individuals identified in the frame, the location of the frame, audio analyzed from the frame, and/or similarity of the frame to other media such as shared photos. In some embodiments, memorable frames may be based on analyzing the audio of a video. For example, audio analysis may be used to recognize certain individuals speaking; a particular pattern of audio such as clapping, singing, laughing, etc.; the start of dialogue; the duration of dialogue; the completion of dialogue; or other similar audio characteristics. In some embodiments, the frames selected are based on the time interval the frames occur in the video. For example, a frame may be selected at every fixed interval. As an example, in the event the set fixed time interval is five seconds, a frame is extracted from the video every five seconds and analyzed for classification. In some embodiments, the frames selected are key frames. In some embodiments, the frames selected are based on the beginning or end of a transition identified in the video. In some embodiments, the frames selected are based on the encoding used by the video. In some embodiments, the frames selected include the first frame of the video.

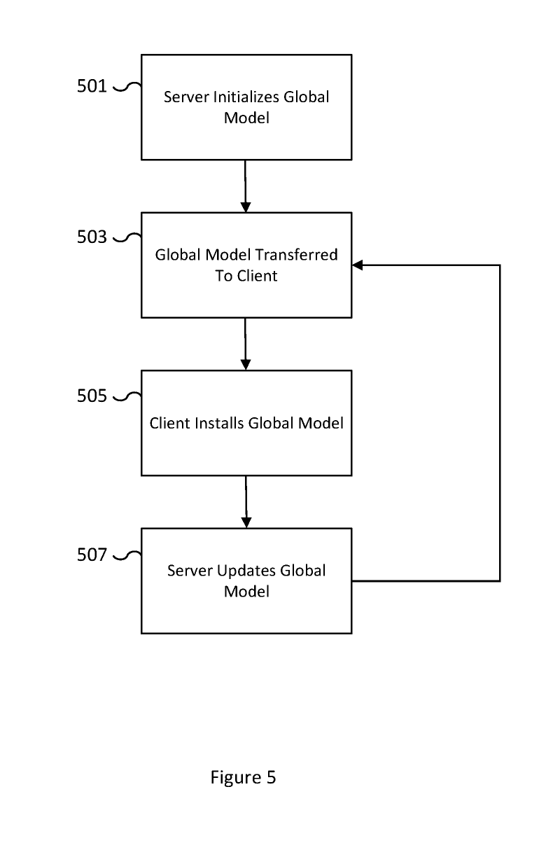

FIG. 5 is a flow diagram illustrating an embodiment of a process for the creation and distribution of a machine learning model. In some embodiments, the process of FIG. 5 is implemented on clients 101, 103, 105, and 107 and server 121 of FIG. 1. In some embodiments, the client described in FIG. 5 may be any one of clients 101, 103, 105, and 107 of FIG. 1 and the server described in FIG. 5 is server 121 of FIG. 1. In some embodiments, the client and the server are separate processes that execute on the same physical server machine or cluster of servers. For example, the client and server may be processes that run as part of a cloud service. In some embodiments, the process of 503 may be performed as part of or prior to 301 and/or 303 of FIG. 3.

In the example shown, at 501, a server initializes a global machine learning model. In some embodiments, the initialization includes the creation of a corpus and the model weights determined by training the model on the corpus. In some embodiments, the data of the corpus is first automatically augmented prior to training. For example, in some embodiments, image processing techniques are applied on the corpus that provide for a more accurate model and improve the inference results. In some embodiments, image processing techniques may include rotating, scaling, and skewing the data of the corpus. In some embodiments, motion blur is removed from the images in the corpus prior to training the model. In some embodiments, one or more different forms of motion blur are added to the corpus data prior to training the model. The result of training with the corpus is a global model that may be shared with multiple clients who may each have his or her unique set of digital media.

At 503, the global model including the trained weights for the model is transferred to a client. For example, a client smartphone device with a camera for capturing photos and video installs a media sharing application. As part of the application, the application installs a global model and corresponding trained weights. In some embodiments, the model and appropriate weights are transferred to the client with the application installation. In various embodiments, once the application is installed, the application fetches the model and appropriate weights for download. In some embodiments, weights are transferred to the client when new weights are available, for example, when the global model has undergone additional training and new weights are determined. In some embodiments, once the model architecture is determined and model weights are trained, the model and weights are converted to a serialized format and transferred to the client. For example, the model and weights may be converted to serialized structured data for download using a protocol buffer.

At 505, the client installs the global model received at 503. For example, a serialized representation of the model and weights is transferred at 503 and unpacked and installed at 505. In some embodiments, a version of the global model is used by the client for inference to determine media desired for sharing. In some embodiments, the output of inference on detected media, additional context of the media, and/or user preferences based on the sharing desirability of media are used to refine the model and model weights. For example, in some embodiments, a user may mark media hidden to reflect the media as not desirable for sharing. The hidden media may be used to modify the model. In some embodiments, the additional refinements made by clients are shared with a server. In some embodiments, only information from media desired for sharing is shared with the server. In this manner, any non-sharable data remains on the client. In some embodiments, contextual information of detected media, as described in additional detail below, is shared with the server. In some embodiments, a server receives additional information to improve the model and weights. In some embodiments, an encoded version of media not desirable for sharing is used to improve the model. In some embodiments, the encoding is a one-way function such that the original media cannot be retrieved from the encoded version. In this manner, media not desirable for sharing may be used to improve the model without sharing the original media.

At 507, the server updates the global model. In some embodiments, the corpus is reviewed and new weights are determined. In some embodiments, the model architecture is revised, for example, by the addition or removal of convolution or pooling layers, or similar changes. In some embodiments, the additional data received by clients is fed back into the model to improve inference results. In some embodiments, decentralized learning is performed at the client and partial results are synchronized with the server to update the global model. For example, one or more clients may adapt the global model locally. The adapted global models are sent to the server by clients for synchronization. The server synchronizes the global model using the client adapted models to create an updated global model and weights. The result of 507 may be an updated model and/or updated model weights.

In the event the global model is updated at 507, at 503, the updated global model is transferred to the client. In various embodiments, the model and/or appropriate weights are refreshed at certain intervals or events, such as when a new model and/or weights exist. As an example, a client is notified by a silent notification that a new global model is available. Based on the notification, the client downloads the new global model in a background process. As another example, a new global model is transferred when a media sharing application is in the foreground and has determined that a model update and/or updated weights exist. In some embodiments, the update occurs automatically without user interaction.

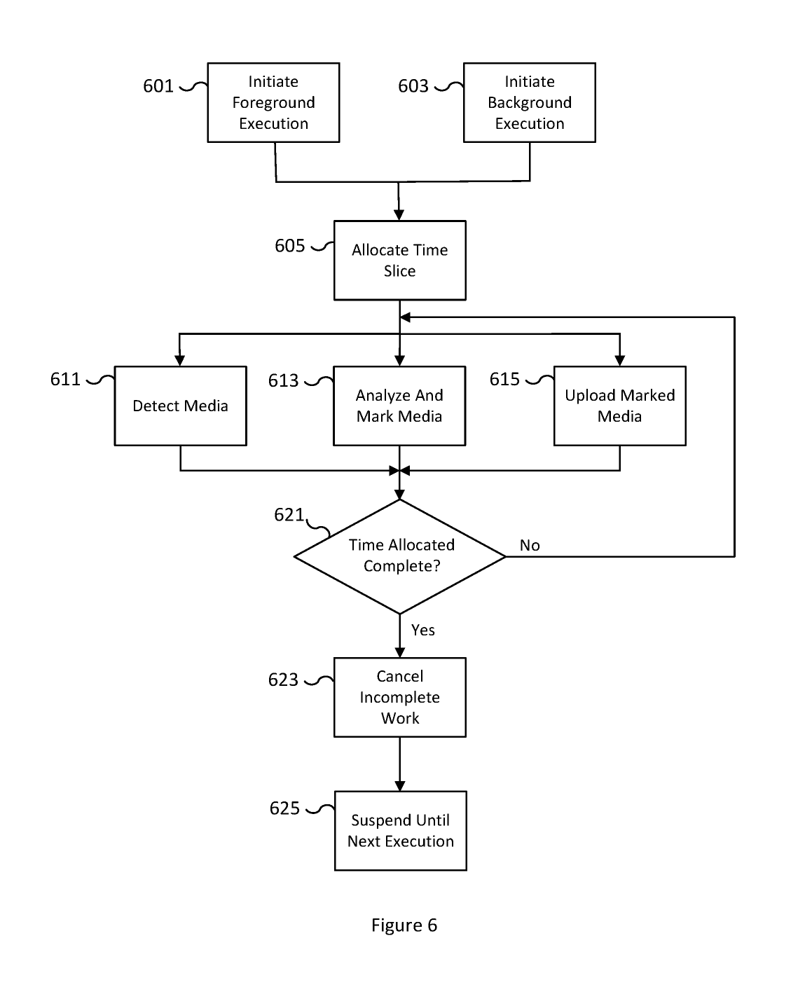

FIG. 6 is a flow diagram illustrating an embodiment of a process for automatically sharing desired digital media. In some embodiments, the process of FIG. 6 is implemented on clients 101, 103, 105, and 107 of FIG. 1. In some embodiments, the process of FIG. 6 is implemented on a server machine, such as server 121 of FIG. 1, or a cluster of servers that run as part of a cloud service. In some embodiments, the process of FIG. 6 is performed by a media sharing application running on a mobile device.

In the example shown, the initiation of automatic sharing of desired digital media can be triggered from either a foreground process at 601 or a background process at 603. At 601, an application running in the foreground initiates the automatic sharing of desired digital media. For example, a user opens a media sharing application that may be used for viewing and interacting with shared digital media. In some embodiments, the foreground process initiates automatic sharing of desired digital media. In various embodiments, the foreground application creates a separate process that initiates automatic sharing of desired digital media.

At 603, background execution for automatic sharing of desired digital media is initiated. In some embodiments, the background execution is initiated via a background process. In various embodiments, background execution is triggered by an event that wakes a suspended application. In some embodiments, events are monitored by the operating system of the device, which wakes a suspended application when system events occur. In some embodiments, background execution is triggered by a change in location event. For example, on some computer systems, an application can register to be notified when the computer system device changes location. For example, in the event a mobile device transitions from one cell tower to another cell tower, a change of location event is triggered. As another example, in the event a device's change in location exceeds a threshold, as determined using a location system such as a global positioning system, a change of location event is triggered. In the event a change in location event occurs, a callback is triggered that executes background execution for automatic sharing of desired digital media. As an example, a change in location event results in waking a suspended background process and granting the background process execution time.

In some embodiments, background execution is triggered when a notification event is received. When a notification arrives at a device, a suspended application is awoken and allowed background execution. When a notification is received, a callback is triggered that executes background execution for automatic sharing of desired digital media. In some embodiments, notifications are sent at intervals to trigger background execution for automatic sharing of desired digital media. In some embodiments, the notifications are silent notifications and initiate background execution without alerting the user. In some embodiments, the sending of notifications is optimized for processing the automatic sharing of desired digital media, for example, by adjusting the frequency and/or timing notifications are sent. In some embodiments, notification frequency is based on a user's expected behavior, history, location, and/or similar context. For example, in the event a user frequently captures new media during Friday evenings, notifications may be sent more frequently during that time period. As another example, in the event a user frequently captures new media when the user's location and/or media location are identified as a restaurant, notifications may be sent more frequently in the event the user's location is determined to be at a restaurant. As another example, in the event a user rarely captures new media during sleeping hours, notifications may be sent very infrequently or disabled during those hours.

In some embodiments, background execution is triggered when a system event occurs. As an example, in the event a device comes into WiFi range, the device may switch from a cellular network to a WiFi network and initiate a change in network connectivity event. In some embodiments, in the event a device connects to a WiFi network, a callback is triggered that executes background execution for automatic sharing of desired digital media. As another example, a system event may include when a device is plugged in for charging and/or connected to a power supply. In some embodiments, the execution in 601 and 603 is performed by threads in a multi-threaded system instead of by a process.

Execution initiated by a foreground process at 601 and execution initiated by a background process at 603 proceed to 605. At 605, execution for automatic sharing of desired digital media is triggered from 601 and/or 603 and a time slice for processing the automatic sharing of desired digital media is allocated. In some embodiments, the time slice is allocated by setting a timer. In some embodiments, the duration of the timer is tuned to balance the processing for the automatic sharing of desired digital media with the operation of the device for running other applications and services. In some embodiments, the duration of the timer is determined based on an operating system threshold and/or monitoring operating system load. For example, the duration is set such that the system load for performing automatic sharing of desired digital media is below a threshold that the operating system determines would require terminating the automatic sharing process. In some embodiments, the process for automatic sharing of desired digital media includes monitoring system resources and adjusting the timer accordingly. In various embodiments, the time slice may be determined based on a queue, a priority queue, process or thread priority, or other similar techniques.

Once a time slice has been allocated in 605, at 611, digital media is detected. For example, new and/or existing digital media on the device is detected and prepared for analysis. In some embodiments, only unmarked digital media is detected and analyzed. For example, once the detected digital media is analyzed, it is marked so that it will not be detected and analyzed on subsequent detections. In some embodiments, a process is run that fetches any new digital media, such as photos and/or videos that were created, taken, captured, or otherwise saved onto the device since the last fetch. In some embodiments, the process of 611 is performed at 301 of FIG. 3.

Once a time slice has been allocated in 605, at 613, detected digital media is analyzed and marked based on the analysis. In some embodiments, the digital media that is analyzed is the media detected at 611. In the example shown, the analysis uses machine learning techniques that apply inference on the new media detected. The inference is performed on the client device and classifies the media into categories. Based on the classification, the media is marked as desirable for sharing or not desirable for sharing. In some embodiments, the process of 613 is performed at 303 of FIG. 3.

Once a time slice has been allocated in 605, at 615, media that has been detected, analyzed, and marked as desirable for sharing is uploaded to a digital media sharing server. In some embodiments, additional metadata of the media desirable for sharing is also uploaded. For example, additional metadata may include information related to the output of inference on the digital media such as classified categories; properties of the media including its size, color depth, length, encoding, among other properties; and context of the media such as the location, camera settings, time of day, among other context pertaining to the media. In some embodiments, the media and any additional metadata are serialized prior to uploading. In some embodiments, the process of 615 is performed at 305 of FIG. 3.

In some embodiments, the processes of 611, 613, and 615 may be run in separate stages in processes (or threads) simultaneously and output from one stage may be shared with another stage via inter-process communication. For example, the newly detected media from 611 may be shared with the process of 613 for analysis via inter-process communication. Similarly, the media marked desirable for sharing from 613 may be shared via inter-process communication with the process of 615 for uploading. In some embodiments, the processing of 611, 613, and 615 is split into chunks for batch processing. In some embodiments, the stages of 611, 613, and 615 are run sequentially in a single process.

At 621, the time slice allocated in 605 is checked for completion. In the event the time slice has completed, execution proceeds to 623. In the event the time slice has not completed, processing at 611, 613, and 615 resumes until the time slice completes and/or the time slice is checked at 621 again. In this manner, the processing at 611, 613, and 615 may be performed in the background while a user interacts with the device to perform other tasks. In some embodiments, in the event the processing at 611, 613, and 615 completes prior to the time slice completing, the processes at 611, 613, and 615 may wait for additional data for processing. The execution of 621 follows from the execution of 611, 613, and 615. In some embodiments, the process of 621 is triggered by the expiration of a timer set in 605.

In the event that the time slice allocated for the processing of automatic sharing of desired digital media has completed in 621, at 623, any incomplete work is cancelled. Incomplete work may include work to be performed by 611, 613, and 615. In some embodiments, the progress of work performed by 611, 613, and 615 is recorded and suspended. In the event additional time is later granted, the work performed by 611, 613, and 615 resumes. In various embodiments, the work may be cancelled and in the event additional execution time is granted, previously completed partial work may need to be repeated. For example, in the event inference is run on a photo that has not completed classification, the photo may require repeating the classification analysis when execution resumes.

Once any incomplete work has been cancelled at 623, at 625, the processing for automatic sharing of desired digital media is suspended until the next execution. For example, once the time allocated for processing completes, the process(es) performing the automatic sharing of desired digital media are suspended and placed in a suspended state. In some embodiments, the processes associated with 611, 613, and 615 are suspended. In some embodiments, the processes associated with 611, 613, and 615 are terminated and control returns to a parent process that initiated them. In some embodiments, a parent process performs the processing of 605, 621, 623, and/or 625. In some embodiments, the resources required for the automatic sharing of desired digital media while in a suspended state are minimal and the majority of the resources are reallocated by the system to other tasks.

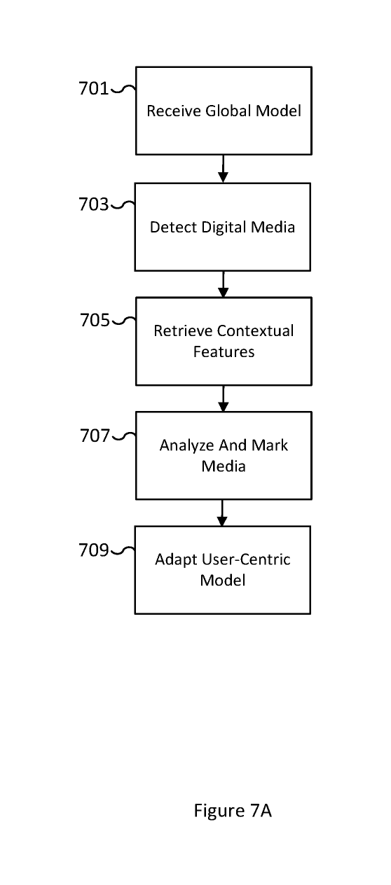

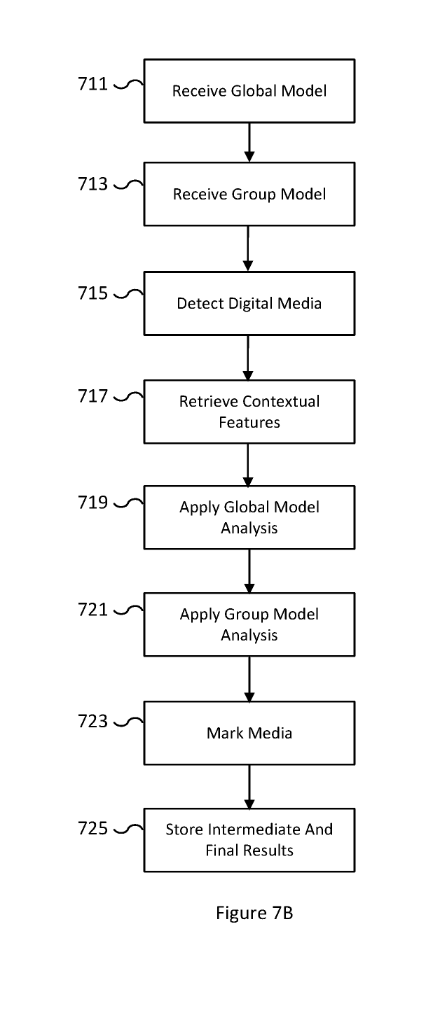

FIG. 7A is a flow diagram illustrating an embodiment of a process for applying a context-based machine learning model. In some embodiments, the process of FIG. 7A is implemented on clients 101, 103, 105, and/or 107 and/or server 121 of FIG. 1. In some embodiments, the process of FIG. 7A may be performed as part of or prior to 301 and/or 303 of FIG. 3.

In the example shown, at 701, a client receives a global model. For example, a global machine learning model and trained weights are transferred from a server to a client device. In some embodiments, a CNN model is received for running inference on digital media. At 703, digital media is automatically detected for the automatic sharing of desired digital media. For example, newly created media is detected and queued for analysis. At 705, contextual features are retrieved. The contextual features are features related to the context of the digital media and may include one or more features as described herein. In some embodiments, contextual features may be based on features related to the location of the media, recency of the media, frequency of the media, content of the media, and other similar contextual properties associated with the media. Examples of contextual features related to the recency and frequency of media include but are not limited to: time of day, time since last media was captured, number of media captured in a session, depth of media captured in a session, number of media captured within an interval, how recent the media was captured, and how frequent media is captured. Examples of contextual features related to the location of the media include but are not limited to: location of the media as determined by a global positioning system, distance the location of the media is relative to other significant locations (e.g., points of interest, frequently visited locations, bookmarked locations, etc.), distance traveled since the last location update, whether a location is a public place, whether a location is a private place, status of network connectivity of the device, and WiFi connectivity status of the user. Examples of contextual features related to the content of the media include but are not limited to: number of faces that appear in the media, identity of faces that appear in the media, and identification of objects that appear in the media. Additional contextual features include lighting information, the different poses of the people in the media, and the camera angle the scene was captured. For example, different camera angles can impact user engagement since they result in images having perspectives that are more or less flattering depending on the perspective used. In some embodiments, the contextual features are based on the machine learning model applied to the media, such as the version of the model applied and/or classification scores.

In some embodiments, the contextual features originate from sensors of the device, such as the global positioning system or location system, real-time clock, orientation sensors, accelerometer, or other sensors. For example, the context may include the time of day, the location, and the orientation of the device when the detected digital media of 703 was captured. In some embodiments, the contextual features include context based on similar media or previously analyzed similar media. For example, the location of a photo may be determined to be a public place or a private place based on other media taken at the same location. As an example, video of a football stadium is determined to be taken in a public place if other media taken at the stadium is characterized as public. As another example, a photo taken in a doctor's office is determined to be taken in a private place if other media taken at the doctor's office is characterized as private.

In some embodiments, a location is determined to be a public place if one or more users shared media from the location previously. In some embodiments, the location is determined to be a private location if the user has previously desired not to share media of the location. As another example, contextual information includes individuals who have viewed similar media and may be interested in the detected media. Additional examples of contextual information based on similar media or previously analyzed similar media include similarity of the media to recently shared or not shared media.

In some embodiments, the contextual features include context within the digital media detected. For example, contextual features may include the identity of individuals in the digital media, the number of individuals (or faces) in the digital media, the facial expressions of individuals in the digital media, and other similar properties. In some embodiments, the contextual features include context received from a source external to the device. As an example, contextual features may include reviews and/or ratings of the location at which the media was taken. In the scenario that a photo taken at a restaurant is detected, contextual information of the photo may be retrieved from an external data source and may include a rating of the restaurant, sharing preferences of past patrons of the restaurant, and/or the popularity of the restaurant.

After the contextual features at 705 are retrieved, at 707, the detected media is analyzed and marked as not desirable for sharing or desirable for sharing by classifying the detected media in part based on the context. For example, detected media is classified using a context-based model to determine categories for the media. Based on the categories, the media is marked as desirable for sharing or not desirable for sharing. In some embodiments, the specific actions performed at 707 are described with respect to FIG. 4 but using a context-based model. In some embodiments, a context-based machine learning model is trained on a corpus curated using training data that contains context associated with the media and classified into categories. In some embodiments, the categories have an associated desirability for sharing. In some embodiments, the context is used as input into a machine learning model, such as a multi-classifier, where values based on the context are features of the model. In some embodiments, the weighted outputs of a classification layer, such as the final layer of a Convolutional Neural Network layer or an intermediary layer, are combined with the context as features to a linear model. The linear model, such as a Logistic Regression binary classifier, may combine contextual and deep learned features into an input vector which is used for classification. In some embodiments, the deep learned model and linear model are combined into an ensemble learner which may use a weighted combination of both models. In some embodiments, a Meta Learner may be trained to learn both models in combination. In some embodiments, the trained weights based on the contextual features are used to create a model for classification.

Once the detected media has been analyzed for classification and marked as desirable or not desirable for sharing, at 709, a user-centric model may be adapted. In some embodiments, a user-centric model is a context-based model that is personalized to an individual or group of users. For example, a user-centric model is a context-based model that is created or updated based on feedback from a user or group of users. In some embodiments, the user-centric model is based on the results of analysis from 707. In various embodiments, a user-centric model is based on user feedback and combines content features and contextual features. In some embodiments, the user-centric model created or updated in 709 is used for analysis in 707.

In some embodiments a user-centric model is a machine learning model specific to a particular user. In some embodiments, a user-centric model is individualized for a particular user based on the user's feedback. For example, a personalized user-centric model is based on implicit feedback from the user, such as photos a user chooses not to share. In some embodiments, a user-centric model is a machine learning model specific to a group of users and is adapted from a global model. For example, a global model is adapted based on the feedback of a group of users. In some embodiments, the user group is determined by a clustering method.

In various embodiments, the analysis performed at 707 and the user-centric model adapted in 709 are used to revise a global model. For example, a global model is trained and distributed to clients for use in classification. Based on the results of the global model and contextual features of the detected media, a user-centric model is adapted. In some embodiments, the feedback from the global model and/or the user-centric model is used to revise the global model. Once revised, the global model may be redistributed to clients for analysis and additional revision.

FIG. 7B is a flow diagram illustrating an embodiment of a process for applying a multi-model context-based machine learning architecture. In some embodiments, the specific actions performed in FIG. 7B are described with respect to FIG. 7A using a multi-model context-based machine learning architecture. In some embodiments, the process of FIG. 7B is implemented on clients 101, 103, 105, and/or 107 and/or server 121 of FIG. 1. In some embodiments, the process of FIG. 7B may be performed as part of or prior to 301 and/or 303 of FIG. 3.

In the example shown, at least two models are utilized in a multi-model context-based machine learning architecture. Each model is independently trained and different models may have different inputs and outputs from one another. For example, in a two-model architecture, the first model may be trained on a large variety of images and infers the category the image belongs to. Thus the result of inference run on the first model is the likelihood that the source image belongs to one of a category of images and/or contains one of many objects. The first model may be used to determine whether an image is one of people, documents, nudity, and/or nature, as a few examples. As another example, the first model may be used to determine the likelihood the image contains one or more objects such as a person, a vehicle, a flower, a fish, a mammal, a tree, and/or an appliance, as a few examples. The second model is trained on the output of the first model as well as additional input features such a context-based features. As described previously, context-based features may include location information, lighting information, the number of faces in the image, the identity of the people in the image, whether the location is a public or private place, and/or whether WiFi is available at the location, as a few examples. The output of the inference applied to the second model is used for marking the media for potential sharing. For example, the analysis of the second machine learning model may be used to mark the media as not desirable for sharing.

By using a cascading two-model architecture, each model may be trained differently and the data curating required for the training sets may be performed independently. Moreover, each model may evolve independently in multiple dimensions such as in feature set, training corpus, as well as revisions over time. For example, many research institutions may work together to create a public, open-source, image categorization machine learning model and corpora. By pooling resources together, such as computing cycles and training data, a very accurate model can be created for categorization and shared among different institutions. A jointly developed, pre-trained, first model may have multiple applications in different domains. For example, an image classifier may be used to identify cucumbers from other vegetables or differentiate between vehicles, humans, and traffic signs for an autonomous vehicle. A second model may then be used to target a more refined and specific application, such as the determination of whether an image is desirable for sharing. The requirements for the training corpus of the second model may be stricter and require unique specialization and curating to create a valuable and accurate model. In some scenarios, however, the amount of data required and the computing resources for training the second model are much less demanding than the requirements for the first model.

In the example shown, at 711, a client receives a global model. For example, a global machine learning model and trained weights are transferred from a server to a client device. In some embodiments, a CNN model is received for running inference on digital media. In some embodiments, the global machine learning model utilizes a stacked convolutional auto-encoder. In some embodiments, the global model is a generic model shared across the vast majority of users. The global model may be used to categorize an image into one of many categories as described above.

At 713, a client receives a group model. For example, a group machine learning model and trained weights are transferred from a server to a client device. In some embodiments, a CNN model is received for running inference on the result of a first model. In some embodiments, the group model is customized to the preferences of the user and/or the user's target audience. In some embodiments, users and/or audiences with similar preferences are clustered together and share a group model. Thus a group model may be trained based on the preferences of one or more users and/or target audience groups. For example, different groups of users may have different sensitivities or preferences for the level of nudity required for a media to be not desirable for sharing. In some embodiments, the group model takes as input the output of a first global model and context information related to the input of the first model.

In some embodiments, a group model is created and trained to identify and target a particular audience or demographic. For example, an advertiser can determine a particular target audience or demographic for shared media advertisements. A machine learning model is created based on the behavior and preferences of the target audience. In some embodiments, the model used is a group machine learning model to present engaging media, including engaging advertisements, to the target audience. In some embodiments, the model is used to identify or refine advertisements targeting the particular audience. For example, advertisements may be benchmarked using an engagement metric based on the likelihood of engagement with the target audience by inferring an engagement metric using the group model. In some embodiments, a collection of candidate advertisements is presented as a steam of media to the machine learning model. Advertisements resulting in a high metric of engagement for a particular target audience may be automatically shared. In this manner, advertisements may be matched to the target audience that most desires to view the advertisement. Conversely, candidate advertisements with a low likelihood of engagement are not shared and the sharing of low engagement advertisements may be avoided.

At 715, digital media is automatically detected for the automatic sharing of desired digital media. For example, newly created media is detected and queued for analysis. At 717, contextual features are retrieved. The contextual features are features related to the context of the digital media and may include one or more features as described herein. In some embodiments, contextual features may be based on features related to the location of the media, recency of the media, frequency of the media, content of the media, and other similar contextual properties associated with the media. Examples of contextual features related to the recency and frequency of media include but are not limited to: time of day, time since last media was captured, number of media captured in a session, depth of media captured in a session, number of media captured within an interval, how recent the media was captured, and how frequent media is captured. Examples of contextual features related to the location of the media include but are not limited to: location of the media as determined by a global positioning system, distance the location of the media is relative to other significant locations (e.g., points of interest, frequently visited locations, bookmarked locations, etc.), distance traveled since the last location update, whether a location is a public place, whether a location is a private place, status of network connectivity of the device, and WiFi connectivity status of the user. Examples of contextual features related to the content of the media include but are not limited to: number of faces that appear in the media, identity of faces that appear in the media, and identification of objects that appear in the media. Additional contextual features include lighting information, the different poses of the people in the media, and the camera angle the scene was captured. For example, different camera angles can impact user engagement since they result in images having perspectives that are more or less flattering depending on the perspective used. In some embodiments, the contextual features are based on the machine learning models applied to the media, such as the version of the group model applied and/or classification scores of the global model.

In some embodiments, the contextual features originate from sensors of the device, such as the global positioning system or location system, real-time clock, orientation sensors, accelerometer, or other sensors. For example, the context may include the time of day, the location, and the orientation of the device when the detected digital media of 715 was captured. In some embodiments, certain contextual features are retrieved from a remote service. For example, a weather service may be remotely accessed to retrieve the weather, such as the temperature, at the media's location. In some embodiments, the contextual features include context based on similar media or previously analyzed similar media. For example, the location of a photo may be determined to be a public place or a private place based on other media taken at the same location. As an example, video of a football stadium is determined to be taken in a public place if other media taken at the stadium is characterized as public. As another example, a photo taken in a doctor's office is determined to be taken in a private place if other media taken at the doctor's office is characterized as private.

In some embodiments, a location is determined to be a public place if one or more users shared media from the location previously. In some embodiments, the location is determined to be a private location if the user has previously desired not to share media of the location. As another example, contextual information includes individuals who have viewed similar media and may be interested in the detected media. Additional examples of contextual information based on similar media or previously analyzed similar media include similarity of the media to recently shared or not shared media.

In some embodiments, the contextual features include context within the digital media detected. For example, contextual features may include the identity of individuals in the digital media, the number of individuals (or faces) in the digital media, the facial expressions of individuals in the digital media, and other similar properties. In some embodiments, the contextual features include context received from a source external to the device. As an example, contextual features may include reviews and/or ratings of the location at which the media was taken. In the scenario that a photo taken at a restaurant is detected, contextual information of the photo may be retrieved from an external data source and may include a rating of the restaurant, sharing preferences of past patrons of the restaurant, and/or the popularity of the restaurant.

After the contextual features at 717 are retrieved, at 719, the detected media is analyzed using the global model. In some embodiments, the output of the global model is the likelihood the image belongs to one of many categories and/or the likelihood one or many objects are present in the image. At 721, the final result of the global model analysis from 719 and context information retrieved at 717 are used to apply a group model analysis. In some embodiments, the analysis at 721 corresponds to a likelihood of whether the media is not desirable for sharing. For example, using the classification results from a global model analysis and context information from the detected media, a determination is made via inference using the group model as to whether the detected media is desirable for sharing. The result of 721 is used at 723 to mark the detected media as desirable or not desirable for sharing. In some embodiments, the specific actions performed at 719, 721, and 723 are described with respect to FIG. 4 but using a multi-model context-based machine learning architecture. At 725, any intermediate machine learning results from steps 719 and 721 along with the final results are stored. In some embodiments, the results are stored along with the original media. In some embodiments, only source media marked desirable for sharing is stored whereas media marked not desirable for sharing is not stored. In some embodiments, the media marked not desirable for sharing never leaves the capture device and only the intermediate machine learning results of the media marked not desirable for sharing are stored in its place. In various embodiments, the stored results and/or media is used for additional machine learning model training.

In some embodiments, a group model is a context-based model that is personalized to an individual or group of users. For example, a group model is a context-based model that is created or updated based on feedback from a user or group of users. In some embodiments, the group model is based on the results of analysis from steps 719, 721, and 723. In various embodiments, a group model is based on user feedback, including engagement information, and combines content features and contextual features.

In some embodiments a group model is a machine learning model specific to a particular user. In some embodiments, a group model is individualized for a particular user based on the user's feedback. For example, a personalized group model is based on implicit feedback from the user, such as photos a user chooses not to share. In some embodiments, a group model is a machine learning model specific to a group of users. In some embodiments, the user group is determined by a clustering method.

In various embodiments, the analysis performed at 719 and 721 is used to revise a global and/or group model. For example, a global model is trained and distributed to the majority of clients for use in classification while a group model is trained and distributed to a smaller subset of users that share similar preferences. In some embodiments, the feedback from the global model and/or the group model is used to revise the global model. Once revised, the global model may be redistributed to clients for analysis and additional revision. Based on the results of the global model and contextual features of the detected media, a user-centric or group model is adapted and distributed to clients that share similar preferences.

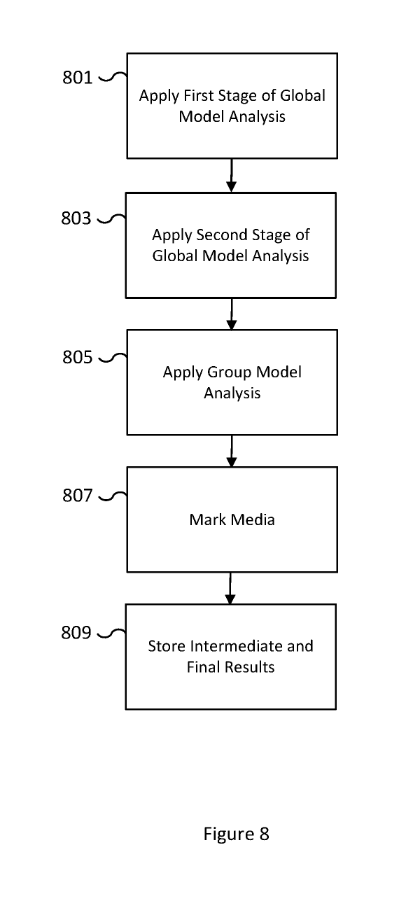

FIG. 8 is a flow diagram illustrating an embodiment of a process for applying a multi-stage machine learning architecture. In some embodiments, the specific actions performed in FIG. 8 are described with respect to FIGS. 7A and 7B but using a multi-model context-based machine learning architecture and utilizing an intermediate machine learning analysis. In some embodiments, the process of FIG. 8 is implemented on clients 101, 103, 105, and/or 107 and/or server 121 of FIG. 1. In some embodiments, the process of FIG. 8 may be performed as part of 303 of FIG. 3 and at 719, 721, 723, and 725 of FIG. 7B.

In the example shown, at least two models are utilized in a multi-model context-based machine learning architecture. Each model is independently trained and different models may have different inputs and outputs from one another. In order to utilize an intermediate machine learning analysis, a global model analysis is split into a first stage and a second stage. At 801, the first stage of the global model analysis is performed on source media, such as a detected media that is a candidate for sharing. The result of the first stage global model analysis is the intermediate machine learning analysis. The output of 801, the intermediate machine learning analysis, is used as input into the second stage of the global model analysis. At 803, the second stage of the global model analysis is performed. In some embodiments, the output of the second stage of the global model analysis corresponds to the likelihood that the image belongs to one of a category of images and/or contains one of many objects. The output at 803 is used as one of the inputs to a group machine learning model analysis performed at 805. In some embodiments, the first stage of the global model corresponds to a first machine learning model component and the second stage of the global model corresponds to a second machine learning model component.

The analyses of 801 and 803 are the result of inference by applying the respective stages of the global model. In some embodiments, the global model used at 801 and 803 is a multi-layer model such that different layers may have fewer inputs than the previous layer. In some embodiments, the global model is a stacked convolutional auto-encoder. For example, the input layer may be constructed to accept inputs based on the depth and size of the detected media. However, subsequent layers may have fewer inputs and corresponding outputs. Thus intermediate layers may have, for example, 1024, 512, or 256 outputs, with the final layer outputting a vector based on the scope of the classification. In the example shown, the first stage of the global model analysis at 801 has more inputs than the second stage of the global model analysis at 803. The final classification result corresponds to the likelihood that the image belongs to one of a category of images and/or contains one of many objects and is used as one of the inputs to a group machine learning model.

In some embodiments, the intermediate machine learning result is used as a lower-dimension representation of the detected media. In some embodiments, the intermediate machine learning result is a low-dimension hash of the detected media. The intermediate result contains enough information to infer the classification of the image but not enough information to transform the image back to the original source media. In some embodiments, the intermediate result may be used as a private version of the detected media. In some embodiments, the inference from the original media to the intermediate result is one directional and thus the original media may not be retrieved from the intermediate result. Thus the intermediate result is an anonymous version that does not visually reveal any identifying information from the source media. For example, an intermediate machine learning result may be used in conjunction with not desirable to share information to train a machine learning model without using the source media that a user (or the system) has marked as not desirable for sharing. In some embodiments, the intermediate machine learning result is used for further analysis, such as training an engagement-based machine learning model. In some embodiments, the intermediate machine learning is a proxy for the source media and may be used for de-duplication. For example, in the event two source media have similar intermediate machine learning results, there is a strong likelihood the second image is very similar (redundant) or a duplicate of the first. In some embodiments, in the event intermediate machine learning results identify a redundant or duplicate image, processing of the image may be terminated and the image is marked as not desirable for sharing.

At 805, the final result of the second stage of global model analysis from 803 is used to apply a group model analysis. In some embodiments, the analysis at 805 relies on context information and the result of inference corresponds to a likelihood of whether the media is not desirable for sharing. For example, using the classification results from a second stage of the global model analysis and context information for the source media, a determination is made via inference using the group model as to whether the detected media is desirable for sharing. The result of 805 is used at 807 to mark the detected media as desirable or not desirable for sharing. In some embodiments, the specific actions performed at 801, 803, and 805 are described with respect to FIG. 4 but using a multi-model context-based machine learning architecture and utilizing an intermediate machine learning analysis. At 809, the intermediate machine learning results and the final results are stored. In some embodiments, the results are stored along with the original media. In some embodiments, only source media marked desirable for sharing is stored whereas media marked not desirable for sharing is not stored. In some embodiments, the media marked not desirable for sharing never leaves the capture device and only the intermediate machine learning results of the media marked not desirable for sharing are stored in its place. In various embodiments, the stored results and/or media is used for additional machine learning model training. As described with respect to FIG. 7B, the global and group model analysis performed may be used to revise a global and/or group model.

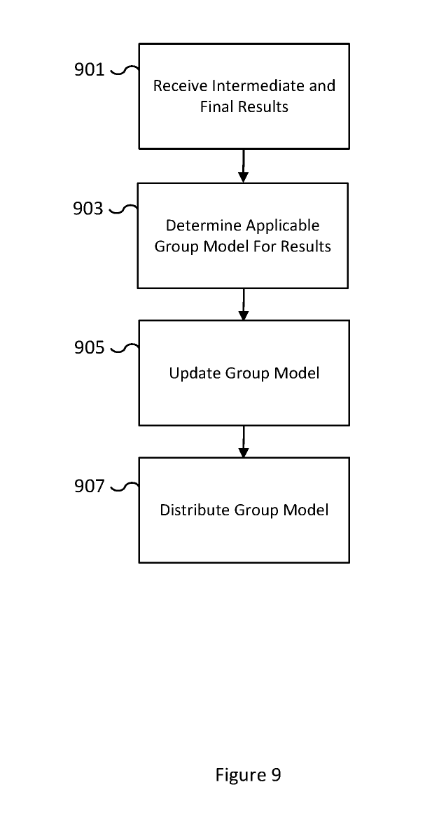

FIG. 9 is a flow diagram illustrating an embodiment of a process for training and distributing a multi-stage machine learning architecture. In some embodiments, the process of FIG. 9 is implemented on clients 101, 103, 105, and/or 107 and/or server 121 of FIG. 1. In some embodiments, the process of FIG. 9 may be performed as part of 503, 505, and 507 of FIG. 5.

In the example shown, at 901, intermediate and final results are received. For example, the output of 725 of FIG. 7B and 809 of FIG. 8 is received and stored. At 903, a determination is made on the applicable group model for the results received at 901. In some embodiments, the users are assigned to a group of one or more users that share preferences. At 903, the application group is determined and the corresponding group model. At 905, the group model is updated. In some embodiments, the update utilizes transfer learning. Thus, results including the intermediate and final results are used to update the group machine learning model. At 907, the revised group model is distributed to applicable users. Once installed, the new model may be used for group model analysis.

In some embodiments, the intermediate machine learning result received at 901 is used for training the revised group model of 905. The intermediate machine learning results may be used as a stand in for the source media in particular when the source media is not desirable for sharing. The intermediate machine learning has the characteristic that the original source media cannot be constructed from the intermediate machine learning results. Thus, the intermediate machine learning results approximate the original source without the same visual representation. Since the conversion from source media to intermediate machine learning results is one directional, sharing the intermediate machine learning results preserves the anonymity of the user who captured the media. In some embodiments, the intermediate machine learning results are used for training not desirable to share media. Without a training data set of intermediate machine learning results, the training for inferring whether a media is not desirable to share would rely largely on data that is the opposite, that is, data that is desirable to share.

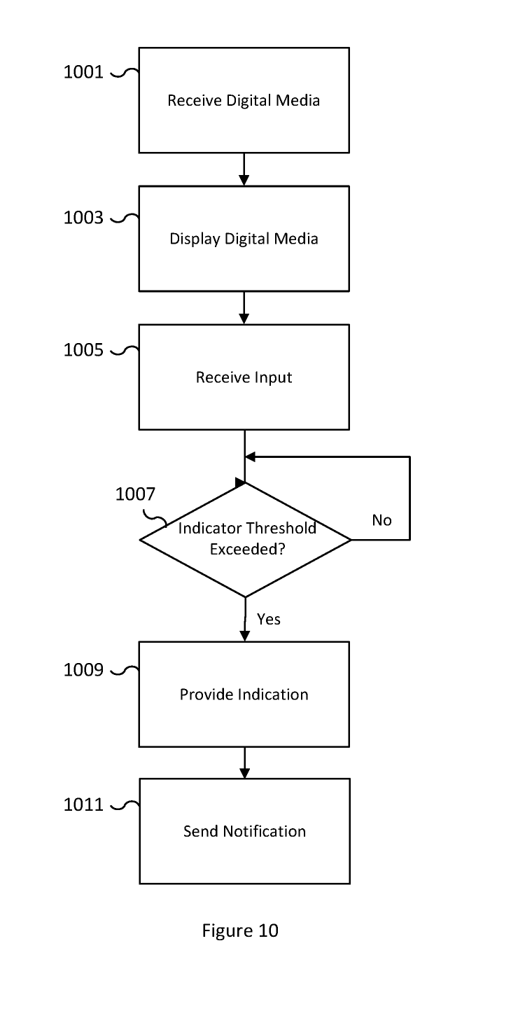

FIG. 10 is a flow diagram illustrating an embodiment of a process for automatically providing digital media feedback. In some embodiments, the process of FIG. 10 is implemented on clients 101, 103, 105, and 107 of FIG. 1. In some embodiments, the process of FIG. 10 is implemented on clients 101, 103, 105, and 107 of FIG. 1 using digital media and properties associated with the digital media received from server 121 over network 111 of FIG. 1. In some embodiments, the properties associated with the digital media are stored in database 127 of FIG. 1. In some embodiments, the digital media is the digital media shared at 305 of FIG. 3.

In the example shown, at 1001, a digital media is received. In some embodiments, the digital media received is digital media shared at 305 of FIG. 3. At 1003, the digital media is displayed on the device. In some embodiments, the received and displayed digital media is part of a collection of digital media for browsing. The displayed media of 1003 is the media currently being browsed. At 1005, user input is received. In some embodiments, the input is user input performed when interacting with the media. In some embodiments, the input is user input performed when viewing the media. For example, when users view media, they may pause on the media, focus their view on certain areas of the media, zoom in on certain portions of the media, and repeat a loop of a certain section of the media (e.g., for videos or animations), among other viewing behaviors. In some embodiments, user input is input primarily associated with the viewing experience of the media and not explicit or intentionally created feedback of the media. In some embodiments, the input received at 1005 is input captured related to viewing behavior. In some embodiments, the input received at 1005 is input captured related to browsing behavior. In some embodiments, the user input is passive input. Examples of passive input include the user stopping at a particular media and gazing at the media, a user hovering over a media using a gesture input apparatus (finger, hand, mouse, touchpad, virtual reality interface, etc.), focus as determined by an eye tracker, heat maps as determined by an eye tracker, and other similar forms of passive input. In some embodiments, the user input is active input, such as one or more pinch, zoom, rotate, and/or selection gestures. For example, a user may pinch to magnify a portion of the media. As another example, a user may zoom in on and rotate a portion of the media. In some embodiments, a heat map can be constructed based on the areas of and the duration of focus.

At 1007, the amount of time the input has been detected is compared to an indicator threshold. In some embodiments, the indicator threshold is the minimum amount of time for the input of 1005 to trigger an indication. For example, in the event the indicator threshold is three seconds, a gaze of at least three seconds is required to trigger a gaze indication. In some embodiments, a user may configure the indicator threshold for each of his or her shared media. In some embodiments, the indicator threshold is based on viewing habits of users. For example, a user that quickly browses media may have an indicator threshold of two seconds while a user that browses slower may have an indicator threshold of five seconds. In some embodiments, the indicator threshold is set to correspond to the amount of time that must pass for a user to indicate interest in a media. As another embodiment, the indicator threshold may be different for each media. For example, a very popular media may have a lower indicator threshold than an average media. In some embodiments, the indicator threshold is based in part on the display device. For example, a smartphone with a large display may have a different indicator threshold than a smartphone with a small display. Similarly, a virtual reality headset with a particular field of view may have a different indicator threshold than a display on a smart camera.

At 1007, in the event the indicator threshold has not been exceeded, processing loops back to 1007. At 1007, in the event the indicator threshold is exceeded, processing continues to 1009. At 1009, an indication is provided. In some embodiments, the indication includes an indication software event. In some embodiments, the indication is a cue to the user that the user's input has exceeded the indicator threshold. In some embodiments, the indication corresponds to the amount and form of interest a viewer has expressed in the currently displayed media. In various embodiments, the indicator may be a visual and/or audio indicator. In various embodiments, the indicator is a user interface element or event. For example, an indication corresponding to a gaze may involve a gaze user interface element displayed on the media. As another example, an indication corresponding to a heat map may involve a heat map user interface element overlaid on the media. Areas of the heat map may be colored differently to correspond to the duration of the user's focus on that area. For example, areas that attract high focus may be colored in red while areas that have little or no focus may be transparent. In another example, areas of focus are highlighted or outlined. In some embodiments, the indication is a form of media feedback. For example, the indication provides feedback to the user and/or the sharer that an indication has been triggered.

In some embodiments, an indictor includes a display of the duration of the input. For example, an indicator may include the duration of the input received at 1005, such as the duration of a gaze. In various embodiments, an icon is displayed that provides information related to the user's and other users' indications and is updated when an indication is provided. For example, an icon is displayed corresponding to the number of users that have triggered an indication for the viewed media. In the scenario that five users have triggered a gaze indication, an icon is displayed on the media that displays the number five for each of the past indications received for the media. In the event a user triggers a gaze indication, the icon is updated to reflect the additional gaze indication and now displays the number six.

In some embodiments, a user interface indication continues to display as long as the input is detected. For example, in the event the indicator threshold is configured to three seconds, once a user gazes at a media for at least three seconds, a fireworks visual animation is displayed over the media. The fireworks visual animation continues to be displayed as long as the user continues to gaze at the media. In the event the user stops his or her gaze, for example, by advancing to a different media, the fireworks animation may cease. As another example, as long as a gaze indication is detected, helium balloon visuals are rendered over the gazed media and are animated to drift upwards.

In some embodiments, the provided indication is also displayed for more than one user. For example, the provided indication or a variation of the indication is displayed for other users viewing the same media. In some embodiments, users viewing the same media on their own devices receive an indication corresponding to input received from other users. In some embodiments, the provided indication is based on the number of users interacting with the media. For example, an animation provided for an indication may increase in intensity (e.g., increased fireworks or additional helium balloon visuals) as additional users interact with the media.

At 1011, a notification corresponding to the indication is sent. In some embodiments, the notification is a network notification sent from the device to a media sharing service over a network such as the Internet. In some embodiments, the network notification is sent to server 121 over network 111 of FIG. 1. The notification may include information associated with the user's interaction with the media. For example, the notification may include information on the type of input detected, the duration of the input, the user's identity, the timestamp of the input received, the location of the device at the time of the input, and feedback from the user. Examples of feedback include responses to the media such as comments, stickers, annotations, emojis, audio messages tagged to the media, media shared in response to the feedback, among others. For example, a user may add a heart emoji and the comment “Remember this?” to the current media. In some embodiments, the network notification may include the comment, the location the comment was placed on the media, the emoji, the location the emoji was placed on the media, the user's identity, the user's location when the emoji and/or comment was added, the time of day the user added the emoji and/or comment, the type of input (e.g., a gaze indication, a focus indication, etc.), the duration of the input, and any additional information related to the input (for example, heat maps associated with the gaze). In various embodiments, the network notification is used to distribute the indication to other users, for example, other users viewing the same media.

In some embodiments, the notification is sent to inform the owner of the media about activity associated with a shared media. For example, the notification may inform the user of interactions such as viewing, sharing, annotations, and comments added to a shared media. In some embodiments, the notifications are used to identify media that was not desired to be shared. For example, in the event a media was inadvertently shared, a notification is received when another user accesses (e.g., views) the shared media. The notification may contain information including the degree to which the media was shared and the type of activity performed on the media. Using the notification information, the owner of the media may trace the interaction on the media and determine the extent of the distribution of the sharing. The notification may include information for the user to address any security deficiencies in the automatic or manual sharing of digital media.

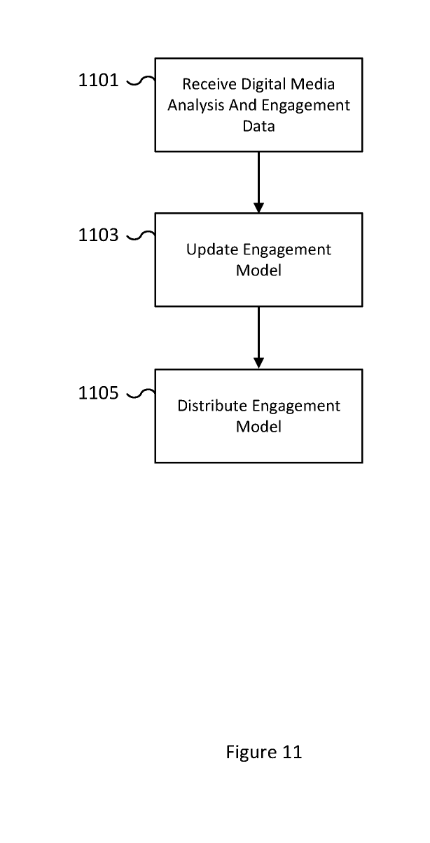

FIG. 11 is a flow diagram illustrating an embodiment of a process for training and distributing an engagement-based machine learning model. In some embodiments, the process of FIG. 11 is implemented on clients 101, 103, 105, and 107 and server 121 of FIG. 1. In some embodiments, the process of FIG. 11 may be performed as part of the process of FIG. 5 and in particular at 507 and 503 of FIG. 5.

In the example shown, an engagement-based machine learning model is created and utilized for identifying and sharing desirable media. In various embodiments, the engagement information relies on feedback from users such as feedback generated in the process of FIG. 10. For example, engagement information is gathered from users of a social media sharing application based on interaction with previously shared media, such as shared photos and videos. The engagement information may be based on feedback such as browsing indicators, comments, depth of comments, re-sharing status, and depth of sharing, among other factors. Examples of browsing indicators include gaze, focus, pinch, zoom, and rotate indicators, among others. The engagement information is then received from the various users and used along with a version of the shared media to train an engagement-based machine learning model. In some embodiments, the engagement-based machine learning model also receives context information related to the shared media and utilizes the context information for training. For example, context information may include the location, the number and/or identity of faces in the media, the lighting information, and whether the location is a public or private location, among other features.

In the example shown, at 1101, digital media analysis results and engagement data are received. The digital media analysis may include the source media, intermediate machine learning analysis, whether the media is not desirable for sharing, and any other digital media analysis results including context information. In some embodiments, the digital media analysis results include the results stored at 725 of FIG. 7B and 809 of FIG. 8. In some embodiments, the engagement data is engagement information based on user interaction with previously shared media.

At 1103, an engagement-based machine learning model is updated. For example, the digital media analysis and engagement data is used to train a machine learning model to infer the likelihood a candidate media is engaging. In some embodiments, the likelihood a media is engaging includes a determination of whether the media is not desirable for sharing. In various embodiments, the likelihood a media is engaging excludes a determination of whether the media is not desirable for sharing. In the event the engagement model excludes a determination of whether the media is not desirable for sharing, the determination of whether the media is not desirable for sharing may be determined using a separate analysis, as described above, and may be performed prior to or after the engagement analysis. In some embodiments, the model updated is based on the user or a group of users that share similar engagement patterns.

At 1105, the engagement-based machine learning model is distributed to clients. In various embodiments, the clients may be clients 101, 103, 105, and 107 and server 121 of FIG. 1. For example, a client such as client 101 may be a smartphone device with a camera for capturing photos and video. Client 101 installs a media sharing application. As part of the application, the application installs an engagement model and corresponding trained weights. In some embodiments, the model and appropriate weights are transferred to the client with the application installation. In various embodiments, once the application is installed, the application fetches the model and appropriate weights for download. In some embodiments, weights are transferred to the client when new weights are available, for example, when the engagement model has undergone additional training and new weights are determined. In some embodiments, once the model architecture is determined and model weights are trained, the model and weights are converted to a serialized format and transferred to the client. For example, the model and weights may be converted to serialized structured data for download using a protocol buffer.

In some embodiments, the clients have passive capture capabilities and utilize the engagement-based machine learning model to determine the subset of media from a passive capture feed that should be automatically recorded and shared. Using a passive capture device, such as a smartphone camera, a wearable camera device, a robot equipped with recording hardware, an augmented reality headset, an unmanned aerial vehicle, or other similar devices, a passive capture feed of the surrounding scene may be analyzed using the engagement model.

In some embodiments, different users or groups of users have dedicated engagement models based on what the user or the group of users find engaging. For example, one group of users may have a particular interest in animals while another group may have an interest in gardens. Different engagement-based models may be distributed to different users or groups of users based on their engagement patterns. In some embodiments, users are clustered into groups based on behavior and/or preferences.

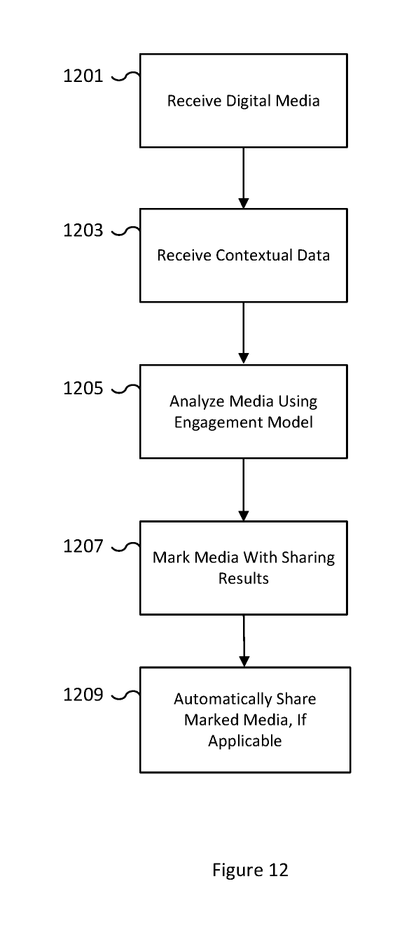

FIG. 12 is a flow diagram illustrating an embodiment of a process for applying an engagement-based machine learning model. In some embodiments, the process of FIG. 12 is implemented on clients 101, 103, 105, and 107 and/or server 121 of FIG. 1. In some embodiments, the process of FIG. 12 may be performed at 301, 303, and 305 of FIG. 3. In the example shown, at 1201, a client receives digital media. For example, a robot equipped with recording hardware receives a passive digital capture feed from a camera sensor. The passive capture feed may be a video feed, a continuous sequence of images, an audio feed, a 3D capture of the scene with depth information, or other appropriate scene capture feed. In some embodiments, the media is not passively captured but instead manually captured and recorded by a human operator. At 1203, the client receives contextual data. The contextual data corresponds to the digital media received at 1201 and includes context information, as described above, such as the location of the capture, the camera angle, the lighting, the number of faces and each person's identity in the scene, and whether the location is a public or private location, among other features. Additional contextual information includes the time lapse between captures, the time the capture was taken, the distance or travel distance between captures, and the last time a candidate media was made not sharable.

At 1205, the client analyzes the media using an engagement-based machine learning model. The analysis takes as input the captured data and the corresponding contextual data. In some embodiments, a video capture feed is split into a sequence of images and the images are analyzed using the engagement-based machine learning model. The engagement-based model is applied to determine the likelihood that the captured media would be engaging in the event it is shared with a target audience. In some passive capture embodiments, a high likelihood of engagement triggers the passive capture device to record the event. In the event the likelihood of engagement drops, the passive capture device stops recording. In some embodiments, the recording is a single image, a sequence of images, or video. In some embodiments, the captured media may not be passively captured but is manually captured. In the event the media is manually captured, an engagement-based machine learning model is used to determine the likelihood that the captured media would be engaging to a target audience. In various embodiments, the output of 1205 is a sharing result. A sharing result includes the metric corresponding to the likelihood a candidate media is determined to exceed an engagement threshold and the candidate digital media. In some embodiments, the sharing result includes an intermediate machine learning analysis as described with respect to FIG. 8. In some embodiments, the sharing result includes certain contextual information from step 1203. For example, the sharing result may include the location and time of day to be displayed with the media in the event the media is later shared.

At 1207, the media is marked with sharing results. In some embodiments, a media with a high likelihood of being engaging is marked as highly engaging. In some embodiments, a media with a high likelihood of being engaging is marked as desirable for sharing. In various embodiments, an additional layer of filtering is performed to remove media determined not desirable for sharing. For example, some media may be highly engaging but based on a user's preference the user would not desire to share the media. To hide media that is not desirable from sharing, the media may be analyzed using a process as described in FIG. 3 to automatically determine whether media is not desirable for sharing. In some embodiments, the engagement analysis using the engagement-based model incorporates the not-desirable to share analysis. In the event the media is marked for sharing, at 1209, the media is automatically shared. For example, the media is uploaded to a server such as server 121 of FIG. 1 for distribution to a targeted audience. In some embodiments, the sharing of the media includes notification to target audience members. In some embodiments, the sharing results are stored with the shared media.

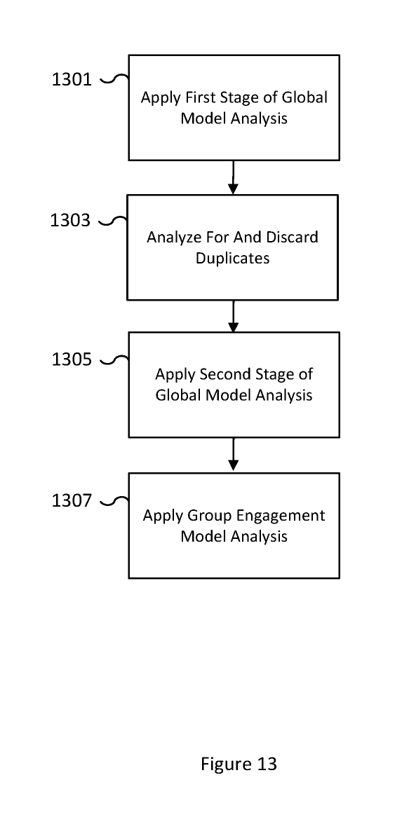

FIG. 13 is a flow diagram illustrating an embodiment of a process for applying a multi-stage machine learning model. For example, using a multi-stage machine learning model allows the process to remove duplicate media from being automatically shared. Moreover, applying an engagement-based machine learning model allows the automatic determination of whether the media has a strong likelihood of being engaging and drives the automatic sharing of only highly engaging media. In some embodiments, the process of FIG. 13 is implemented on clients 101, 103, 105, and 107 and/or server 121 of FIG. 1. In some embodiments, the process of FIG. 13 may be performed as part of the steps of 301, 303, and 305 of FIG. 3 for the automatic sharing of digital media. In some embodiments, the process of FIG. 13 is performed as part of step 1205 of FIG. 12 to analyze media using an engagement-based model.

In the example shown, at 1301, the first stage of a global machine learning model is applied. For example, a robot equipped with recording hardware captures an image from a passive digital capture feed and applies the first stage of a global machine learning model to the captured digital media. The first stage outputs an intermediate machine learning analysis result of the captured media. In some embodiments, the intermediate machine learning analysis result is a low-dimensional representation of the analyzed digital media. In some embodiments, the intermediate machine learning analysis result is a reduced version of the digital media that cannot be used to reconstruct the original source digital media. In this manner, the intermediate machine learning analysis result functions as an identifier of the source digital media while protecting the privacy of the media. Moreover, the first stage of the global model analysis has the property that two visually similar images will result in two similar intermediate machine learning analysis results. At 1303, the intermediate machine learning analysis result is used to analyze the digital media and discard duplicates. In some embodiments, the intermediate machine learning analysis result is compared to previous results to determine whether the media is a duplicate.

In various embodiments, the intermediate machine learning analysis result is a collection of activation function results. In many instances, the results have values close to zero and represent a non-activated value or a low probability that an intermediate node is activated. In some embodiments, intermediate machine learning analysis results may be compared by converting the activation function results into a binary vector. A binary vector representation may be created by converting each floating point activation function result to a binary value of either one or zero. Often, the binary vector results in a spare vector representing many non-activated values. Due to the sparse nature, the vector may be highly compressed. In some embodiments, the binary vector representations of intermediate machine learning analysis results are compared to determine whether a digital media is duplicative of another previously analyzed (and possibly shared) digital media. In the event the binary vector representations are similar, that is, the difference between the two is less than a duplicate threshold, the digital media is determined to be duplicative and is discarded. In some embodiments, the duplication is determined by taking the hamming distance of two binary vector representations of the digital media. In some embodiments, vector versions of the activation function results use floating point values and are compared with one another to determine whether a duplicate exists. In some embodiments, a representation of the intermediate machine learning analysis results of analyzed digital media is collected and stored in a database, such as database 127 of FIG. 1. The use of an intermediate machine learning analysis to identify digital media allows for the media to be stored on a shared server without compromising the visual privacy of the image.

Once duplicates are discarded, at 1305, the second stage of the global model analysis is performed. In some embodiments, the second stage is a classification stage that determines whether an image belongs to one of a category of images and/or contains one of many objects. The result of the second stage of a global model analysis is used as input to step 1307. At 1307, a group engagement model analysis is applied. In some embodiments, the analysis runs inference using the classification result of step 1305 and context information of the digital media to determine the likelihood of engagement. In some embodiments, the processing at 1307 is performed as described in 1205 of FIG. 12 and/or using an engagement-based model as trained in the process of FIG. 11. In various embodiments, the application of the engagement-based model analysis results in a determination of whether the captured digital media has a likelihood of being engaging. In the event the media has a strong likelihood of being engaging, the media is automatically shared using a media sharing service as described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a media;
receiving a context information associated with the media;
using a first machine learning model to analyze the media to determine a classification result;
using a second machine learning model to analyze the classification result and the context information to determine whether the media is likely not desirable to share, wherein the first machine learning model and the second machine learning model have been trained using different machine learning training data sets; and
automatically sharing the media in an event the media is not identified as not desirable to share.

2. The method of claim 1, wherein the second machine learning model is trained on previously shared media.

3. The method of claim 1, wherein the context information associated with the media includes a location, a time of day, a camera angle, or a lighting information of the media.

4. The method of claim 1, wherein the context information associated with the media includes a determination of a number of faces in the media or identities of individuals in the media.

5. The method of claim 1, wherein the first machine learning model and the second machine learning model are updated independently.

6. The method of claim 1, wherein the first machine learning model is a global machine learning model and the second machine learning model is a group machine learning model.

7. The method of claim 6, wherein the group machine learning model is unique to a group of one or more users and based on preferences of the group.

8. The method of claim 1, wherein using the first machine learning model includes using a first machine learning model component and a second machine learning model component.

9. The method of claim 8, wherein the first machine learning model component outputs an intermediate machine learning analysis result and the intermediate machine learning analysis result is used as an input to the second machine learning model component.

10. The method of claim 1, wherein using the first machine learning model includes analyzing the media to determine an intermediate machine learning analysis result and outputting the intermediate machine learning analysis result for additional use as a marker of the media.

11. The method of claim 10, wherein the marker of the media is used to identify the media.

12. The method of claim 10, wherein the media cannot be recreated from the intermediate machine learning analysis result.

13. The method of claim 10, wherein the intermediate machine learning analysis result is a low-dimensional representation of the media.

14. The method of claim 10, wherein the marker of the media is collected and used to further train the second machine learning model to infer whether a candidate media is likely not is desirable to share.

15. The method of claim 10, wherein the marker of the media and the context information are collected to further train the second machine learning model to infer whether a candidate media is likely not desirable to share.

16. The method of claim 10, wherein in the event the media is likely not desirable to share, the marker of the media is used to train a group machine learning model and in the event the media is not likely not desirable to share, the media is used to train the group machine learning model.

17. The method of claim 10, wherein the marker of the media is used to perform a de-duplication associated with the media.

18. The method of claim 17, wherein the de-duplication associated with the media includes converting the intermediate machine learning analysis result into a vector representation of the media.

19. The method of claim 18, wherein the de-duplication utilizes the vector representation of the media to identify a probability that the media is visually similar to a previously shared media.

20. A method, comprising:
using a first machine learning model component to analyze a media to determine an intermediate machine learning analysis result;
using a second machine learning model component to analyze the intermediate machine learning analysis result to determine a classification result; and
outputting the intermediate machine learning analysis result for additional use as a marker of the media.

21. A system, comprising:
a processor; and
a memory coupled with the processor, wherein the memory is configured to provide the processor with instructions which when executed cause the processor to:
receive a media;
receive a context information associated with the media;
use a first machine learning model to analyze the media to determine a classification result;
use a second machine learning model to analyze the classification result and the context information to determine whether the media is likely not desirable to share, wherein the first machine learning model and the second machine learning model have been trained using different machine learning training data sets; and
automatically share the media in an event the media is not identified as not desirable to share.
